(19) United States
(12) Patent Application Publication
(10) Pub. No.: US 2025/0002646 A1
(43) Pub. Date: Jan. 2, 2025

(54) POLYMER

(71) Applicants: The Texas A&M University System, College Station, TX (US); Teysha Technologies Limited, Soham (GB)

(72) Inventors: Karen L. Wooley, College Station, TX (US); Stephen John Clifford Taylor, Soham (GB); Senthil Kumar Boopathi, College Station, TX (US); Ashlee A. Jahnke, College Station, TX (US); Guorong Sun, College Station, TX (US); Hai Wang, College Station, TX (US)

(73) Assignees: The Texas A&M University System, College Station, TX (US); Teysha Technologies Limited, Soham (GB)

(21) Appl. No.: 18/749,963

(22) Filed: Jun. 21, 2024

Related U.S. Application Data
(60) Provisional application No. 63/509,994, filed on Jun. 23, 2023.

(51) Int. Cl. C08G 64/30; C08G 64/02

(52) U.S. Cl. CPC C08G 64/305; C08G 64/0216; C08G 64/0291

(57) ABSTRACT

The present invention provides a polymer, preferably a degradable polymer, derived from monomers (A) and (B) and/or comprising a repeat unit of formula (Ii) and at least one terminal group of formula (II).

### RELATED APPLICATIONS

The present application claims the benefit of U.S. Provisional Application No. 63/509,994, file Jun. 23, 2023, which is herein incorporated by reference in its entirety.

### INTRODUCTION

The present invention relates to a polymer derived from monomers (A) and (B) and/or comprising a repeat unit (I) and a terminal group (II) which is derived from a monomer of the polymer. The present invention also relates to a method for making the polymer. The present invention also relates to a method for performing post-polymerization modification of the polymer as well as to the deprotected polymer which results therefrom. The present invention also relates to a deprotected polymer. The present invention also relates to uses of the polymers and deprotected polymers of the present invention. The present invention also relates to compounds and to their use in preparing a polymer.

### BACKGROUND

Plastics are ubiquitous in our everyday lives, with about 400 million tons produced annually around the globe. While plastics provide high performance and convenience for a large number of applications, the environmental impacts of the industry are becoming increasingly apparent.

Currently, plastic production is heavily reliant on fossil fuels, consuming 6% of global oil, both due to energy consumption during production and the fact that 90% of plastics rely on virgin fossil fuel feedstocks.

In addition to issues with their production, plastic products also have an impact after the end of their useful lifetime, as it is estimated that at least 8 million tons of plastic leak into the oceans each year. Plastics discarded in the natural environment can persist for up to a thousand years, both in bulk form and as microplastics, resulting in accumulation over time.

Over 150 million tons of plastic waste are already in the oceans, and, unless drastic steps are taken to reduce the accumulation of plastics in the future, it is predicted that by 2050 plastic will outweigh fish in the world's oceans.

With increasing media attention and government regulatory actions, consumer awareness of the environmental impacts of plastics is growing, and the market for more sustainable alternatives is expanding. Many industries are searching for pathways to follow through on eco-conscious branding messages for customers who are increasingly demanding corporations to be better stewards of the natural environment.

There is therefore a need to develop materials that can be produced from biomass using a robust synthetic methodology, degrade in a reasonable time period, and achieve broadly-tunable thermal and mechanical properties, making a wide range of applications possible, including single use plastic products, plastic packaging, automobile molding, building materials, personal care products and medical devices, among others.

Macromolecules 2016, 49, 7857-7867 relates to the synthesis of four different polycarbonates. The polycarbonates are derived from triphosgene monomers and one of four glucopyranoside diol monomers. The glucopyranoside diol monomers have free/unprotected hydroxyls in either the 1,4-, 1,6-, 2,6-, or 3,6-positions respectively. The polymerization of glucopyranoside monomers comprising unprotected hydroxyl groups on adjacent carbon atoms is not disclosed.

Macromolecules 2018, 51, 1787-1797 relates to the synthesis and post-polymerization modification of a polycarbonate. The polycarbonate is derived from MBGC five-membered carbonate monomers, and is thus a homopolymer. The polymerization can be described as a chain-growth, addition, ring-opening polymerization. The polycarbonate comprises terminal groups derived from polymerization initiator MBA, a terminator, catalyst DBU, trace water, methanol precipitant, and/or MBGC monomer, the latter of which manifests in a terminal group comprising a glucopyranoside moiety with a free hydroxyl.

JACS Au 2022, 2, 515-521 relates to a study into the synthesis of polycarbonates, in particular into the regiochemistry of the polycarbonates. Each of the polycarbonates is derived from one of three five-membered carbonate monomers: MBGC, MCGC, or MEGC.

Each polycarbonate is therefore a homopolymer. Each of the polymerizations can be described as a chain-growth, addition, ring-opening polymerization, initiated with either a MBA or a mPEG113-OH polymerization initiator.

Journal Of Polymer Science, Part A: Polymer Chemistry 2019, 57, 432-440 relates to the synthesis and post-polymerization modification of a polycarbonate. The polymerization can be described as a chain-growth, addition, ring-opening polymerization, initiated with either a MBA or a mPEG113-OH polymerization initiator.

### SUMMARY OF THE INVENTION

Viewed from a first aspect, the present invention provides a polymer, preferably a degradable polymer, derived from monomers (A) and (B):

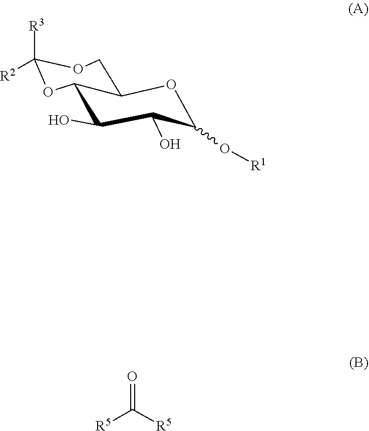

wherein
R¹ is at each occurrence hydrocarbyl with 1 to 40, preferably 1 to 25, C atoms that is optionally substituted and optionally comprises one or more hetero atoms;
R² is at each occurrence H, or hydrocarbyl with 1 to 40, preferably 1 to 25, C atoms that is optionally substituted and optionally comprises one or more hetero atoms;
R³ is at each occurrence H, or hydrocarbyl with 1 to 40, preferably 1 to 25, C atoms that is optionally substituted and optionally comprises one or more hetero atoms;
R⁵ is a leaving group, preferably selected from halogen, imidazole, —OR⁴, —SR⁴, or —N(R⁴)₂;
R⁴ is hydrocarbyl with 1 to 40 C atoms that is optionally substituted and optionally comprises one or more hetero atoms;
each R⁴ may be the same or different,
each R⁵ may be the same or different, preferably the same.

Viewed from another aspect, the present invention provides a polymer, preferably a degradable polymer, comprising a repeat unit of formula (I) and at least one terminal group of formula (II):

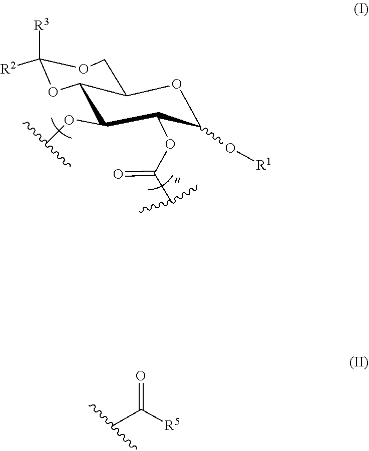

wherein
R¹-R⁵ are as hereinbefore defined;
n is an integer from 2 to 200; and
the at least one terminal group of formula (II) is derived from a monomer of the polymer.

Viewed from another aspect, the present invention provides a process for preparing a polymer of the present invention, wherein said process is a condensation polymerization, and wherein said process preferably comprises reacting a compound of formula (A) with a compound of formula (B)

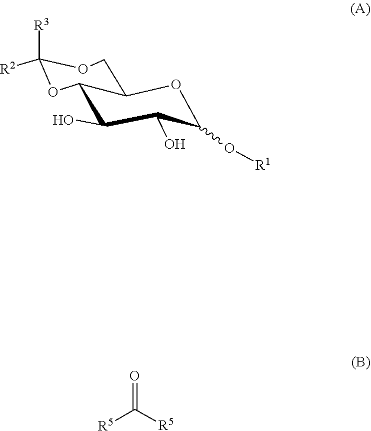

wherein R¹, R², R³, and R⁵ are as hereinbefore defined.

Viewed from another aspect, the present invention provides a polymer obtained or obtainable, preferably obtained, by a process as hereinbefore described.

Viewed from another aspect, the present invention provides a method for preparing a deprotected polymer comprising reacting, preferably deprotecting, a polymer as hereinbefore described to give a deprotected polymer comprising a repeat unit of formula (Ii) and at least one terminal group of formula (II):

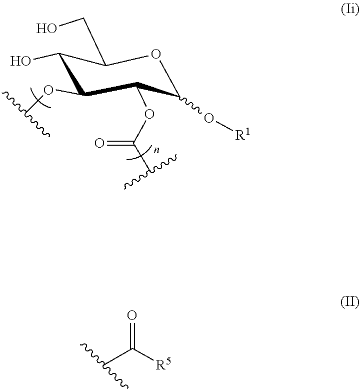

wherein R¹-R⁵ and n are as hereinbefore defined; and
the at least one terminal group of formula (II) is derived from a monomer of the polymer.

Viewed from another aspect, the present invention provides a deprotected polymer obtained or obtainable, preferably obtained, by the method of the present invention of preparing a deprotected polymer.

Viewed from another aspect, the present invention provides a deprotected polymer comprising a repeat unit of formula (Ii) and at least one terminal group of formula (II):

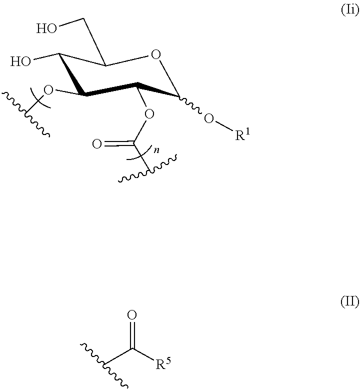

wherein R¹, R⁵, and n are as hereinbefore defined; and
the at least one terminal group of formula (II) is derived from a monomer of the polymer.

Viewed from another aspect, the present invention provides a compound selected from LMG, EEG, and CAG (as defined in Table 1).

Viewed from another aspect, the present invention provides the use of a polymer or deprotected polymer of the present invention as a bio-based, sustainable and/or degradable polymer.

Viewed from another aspect, the present invention provides the use of a polymer or deprotected polymer of the present invention in a packaging material, in a food product, preferably a gum, and more preferably as a gum base, or in a personal care product, among other possibilities.

Advantageously, the processes and methods of the present invention permit a synthetic route from biomass, for example starch, or from starting materials ultimately derived or derivable from biomass, to the compounds, polymers, and deprotected polymers of the present invention. The present invention therefore provides a synthetic route to compounds, polymers, and deprotected polymers which minimises the need for reagents or synthetic steps reliant on fossil fuel feedstocks, reducing the environmental impact of plastic production.

Advantageously, the polymers, deprotected polymers, and compounds of the present invention are ultimately derived or derivable from biomass. The present invention therefore provides polymers which need not be derived from fossil fuel feedstocks, reducing the environmental impact of plastic production.

Further advantageously, the polymers and deprotected polymers of the present invention may preferably be degradable, reducing the negative impact associated with plastic disposal.

As the polymers of the present invention are derivable from biomass, and may preferably be degradable, the negative environmental impact associated with non-degradable polymers derived from fossil fuel feedstocks is advantageously minimised.

Further advantageously, the polymers and deprotected polymers of the present invention may have a desirable diversity of molar mass, thermal, and contact angle properties. The range of polymer parameters that are achievable mean that the polymers of the invention are “tuneable”, i.e. that the polymers can advantageously provide a range of chemical, thermal, degradation and mechanical properties, meaning they can be exploited in a diverse range of end-applications.

Advantageously, the processes and methods of the present invention provide polymers and deprotected polymers having a desirable diversity of molar mass, thermal, and contact angle properties. The range of polymer parameters that are achievable mean that the processes and methods of the present invention allow access to polymers which are “tuneable”, i.e. polymers which can advantageously provide a range of chemical, thermal, degradation and mechanical properties, meaning they can be exploited in a diverse range of end-applications.

### Definitions

As used herein (see Table 1), the term “glucopyranoside starting material” refers to a glucopyranoside used to prepare a glucopyranoside monomer.

As used herein (see Table 1), the term “glucopyranoside monomer” refers to a glucopyranoside used as a monomer in the preparation of polymers of the present invention.

As used herein, the term “copolymer” refers to a polycarbonate derived from more than one species of monomer. For example, a polycarbonate derived from monomers (A) and (B) can herein be termed a copolymer, as it derived from two different monomer species.

In contrast, as used herein, the term “homopolymer” refers to a polycarbonate derived from a single monomer species. For example, Macromolecules 2018, 51, 1787-1797 relates to a polycarbonate derived from a single monomer species which is a five-membered carbonate monomer. No other monomer species are used in the polymerization to afford the polycarbonate. The polycarbonate of Macromolecules 2018, 51, 1787-1797 can therefore herein be termed a homopolymer.

As used herein, the term “carbonylation agent” refers to a reagent which is the source of a carbonyl group present in a polymer macromolecule.

As used herein, the term “post-polymerization modification” refers to the chemical transformation of a polymer. For example, in some of the Examples of the present application, post-polymerization modification comprises a deprotection of a polymer. As used herein, the term “deprotection” refers to the removal of a chemical protecting group to reveal a chemical functional group, for example hydrolysis of an acetal or ketal to reveal a diol. Preferably, the deprotection is selective for a particular protecting group and leaves the rest of the compound unchanged.

As used herein, the term “degradation” refers to the breakdown of a polymer, for example manifested in a reduction in molar mass or degree of polymerization. As used herein, the term “degradable polymer” refers to a polymer which exhibits degradation behaviour, preferably after the polymer or an article comprising the polymer has fulfilled its intended use.

As used herein, a polymer is derived from monomers A and B if the polymer is obtained or obtainable, preferably obtained, by the polymerization of monomers A and B.

As used herein, a terminal group is derived from a monomer of the polymer if the chemical species or reactant which forms the terminal group also forms at least part of the backbone of the polymer, preferably at least part of a repeating unit in the polymer backbone. In such a case, the terminal group is not, for example, derived from a polymerization initiator or a solvent molecule. Conceptually, one can imagine preparing a polymer through the polymerization of labelled monomers. If label is present in the terminal group under consideration as well as in the backbone of the resultant polymer macromolecule, the terminal group is derived from a monomer of the polymer. On the other hand, if the label is present only in the backbone of the resultant polymer macromolecule, and not in the terminal group under consideration, the terminal group is not derived from a monomer of the polymer. It is understood that such a labelling experiment need not be conducted in practice, but is merely presented as an illustrative thought experiment to assist an understanding of the definition.

As used herein, the term “hydrocarbyl” refers to groups notionally derived from the removal of a hydrogen atom from a chemical group comprising carbon and hydrogen. The hydrogen atom may notionally be removed from any carbon atom or heteroatom. A hydrocarbyl group may be substituted or unsubstituted. A hydrocarbyl group may optionally comprise one or more heteroatoms. In other words, a hydrocarbyl group need not consist only of carbon and hydrogen. A hydrocarbyl group may be straight-chained or branched-chained.

As used herein, the term “polymerization initiator” refers to a compound used to initiate a chain-growth polymerization. Initiation is typically achieved by the formation of an active chain-end, permitting propagation by reaction of the active chain-end with monomers. In a chain-growth polymerization, typically one of the termini of the final polymer will be derived from the polymerization initiator.

As used herein, the term “alkyl” refers to groups notionally derived from alkanes by removal of a hydrogen atom from any carbon atom. Alkyl groups may be straight-chained or branched-chained, may optionally comprise one or more heteroatoms, and may be substituted or unsubstituted.

As used herein, the term “alkenyl” refers to groups notionally derived from alkenes by removal of a hydrogen atom from any carbon atom. The hydrogen atom may notionally be removed from an sp² alkene carbon. For example, an alkenyl group may include the styrenyl group and the vinyl group. Equally, the hydrogen atom may notionally be removed from an sp³ carbon elsewhere in the parent alkene. For example, an alkenyl group may include the allyl group and the crotyl group. Alkenyl groups may be straight-chained or branched-chained, may optionally comprise one or more heteroatoms, and may be substituted or unsubstituted.

As used herein, the term “styrenyl” refers to a group according to either of the following formula:

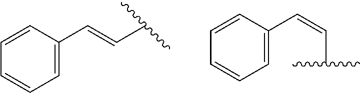 [SMILES: */C=C/c1ccccc1 ; */C=C\c1ccccc1]

which may optionally be substituted.

Preferably, styrenyl groups of the present invention are of the following formula:

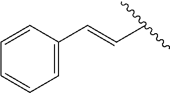 [SMILES: */C=C/c1ccccc1]

which may optionally be substituted.

As used herein, the term “allyl” refers to the group of the following formula:

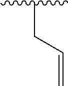 [SMILES: *CC=C]

As used herein, the term “alkynyl” refers to groups notionally derived from alkynes by removal of a hydrogen atom from any carbon atom. The hydrogen atom may notionally be removed from an sp alkyne carbon, or from an sp³ carbon elsewhere in the parent alkyne. Alkynyl groups may be straight-chained or branched-chained, may optionally comprise one or more heteroatoms, and may be substituted or unsubstituted.

As used herein, the term “aryl” also encompasses the term “heteroaryl” and refers to groups notionally derived from arenes by removal of a hydrogen atom from a ring atom, whether a carbon atom or a heteroatom. As used herein, the term “arene” also encompasses the term “heteroarene” and refers to monocyclic and polycyclic aromatic compounds, which may be substituted or unsubstituted and which may optionally comprise one or more heteroatoms either in the aromatic ring(s) or elsewhere.

As used herein, the term “halogen” includes fluorine, chlorine, bromine, and iodine.

As used herein, the term “terminal group” is the same as “end group” and refers to the chemical group at either of the two termini of a polymer macromolecule. The termini are judged with reference to the main chain of the macromolecule (i.e. the longest chain).

As used herein, the term “backbone” refers to the main chain of a polymer macromolecule, discounting the two terminal groups.

As used herein, “Mₙ” refers to number average molar mass.

As used herein, “M_{w}” refers to weight average molar mass.

As used herein, “Mₚ” refers to peak molar mass, e.g., as determined from an analytical method, for instance size exclusion chromatography or MALDI-tof mass spectrometry, which allows for observation of the molar mass distribution.

As used herein, the term “dispersity”, denoted by Ð, is equivalent to “polydispersity index” and is calculated according to Ð=M_{w}/Mₙ

As used herein, “T_{d}” refers to the thermal decomposition temperature, e.g., as measured by thermogravimetric analysis.

As used herein, the term “condensation polymerization” refers to a polymerization where growth of the polymer chain proceeds by repeated condensation reactions. A polymer derived from a condensation polymerization is termed herein a “condensation polymer”.

As used herein in a chemical formula, e.g. in the depiction of a chemical group or repeat unit, a wavy line which is perpendicular to a chemical bond refers to the point of attachment to the rest of a chemical compound or polymer. An example of such a wavy line is given in the depiction of the repeat unit below, where each of the wavy lines illustrates a point where the repeat unit bonds to the rest of the polymer:

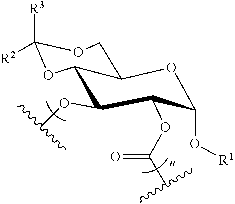

As used herein in a chemical formula, e.g. in the depiction of a chemical group or repeat unit, a wavy line used in place of a chemical bond denotes a mix of stereochemistry. For example, the following formula:

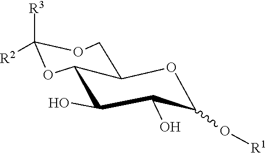

encompasses both of the following stereoisomers:

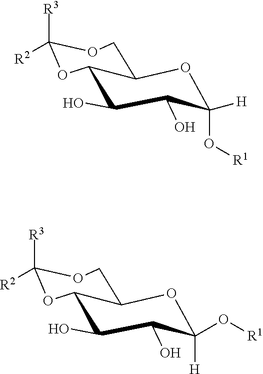

As used herein, the following formula, and its analogues which also comprise a styrenyl group to which a wavy line in attached:

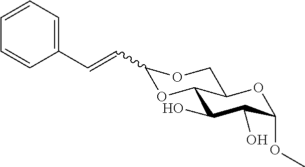

encompasses the following stereoisomers:

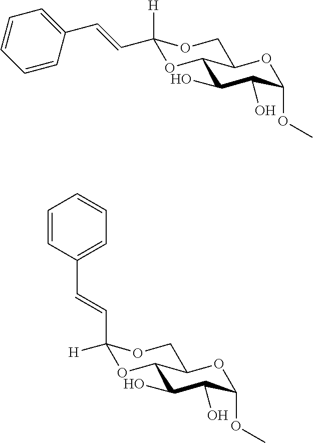

and no comment is made on the geometry (i.e. “cis”/“trans” isomerism) of the styrenyl alkene double bond, which, in all three cases, is drawn as “trans”.

As used herein, repeat units encompass all possible variations of regiochemistry. A repeat unit of formula (I) is taken as an illustrative example:

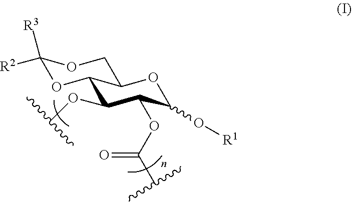

Taking n=2 as an illustrative example, formula (I) encompasses all of the following variations of regiochemistry:

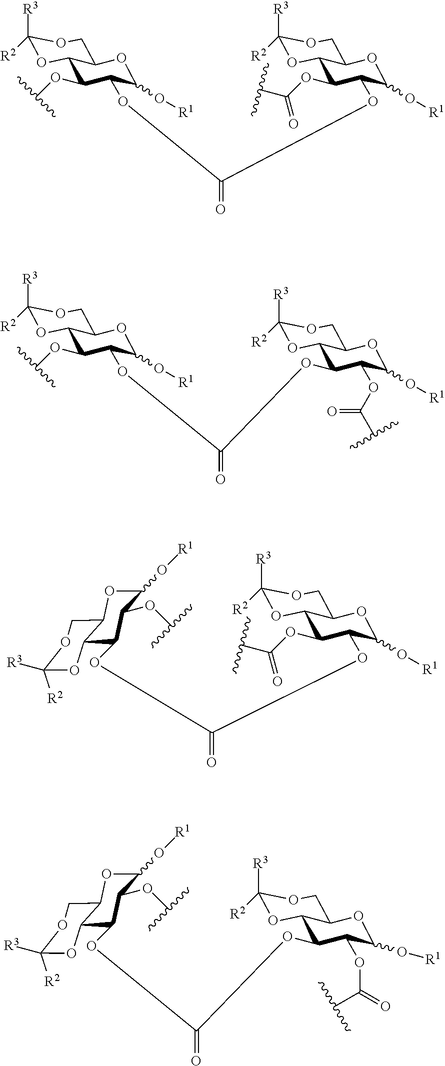

Regardless of the value of “n”, any two adjacent iterations of the repeat units of the present invention will be subject to these regiochemical variations. These regiochemical variations are known in the art and are discussed, for example, in JACS Au 2022, 2, 515-521.

### BRIEF DESCRIPTION OF THE DRAWINGS

FIG. 1 shows monomers (A) and (B) from which a polymer of the invention may be derived.

### DETAILED DESCRIPTION OF THE INVENTION

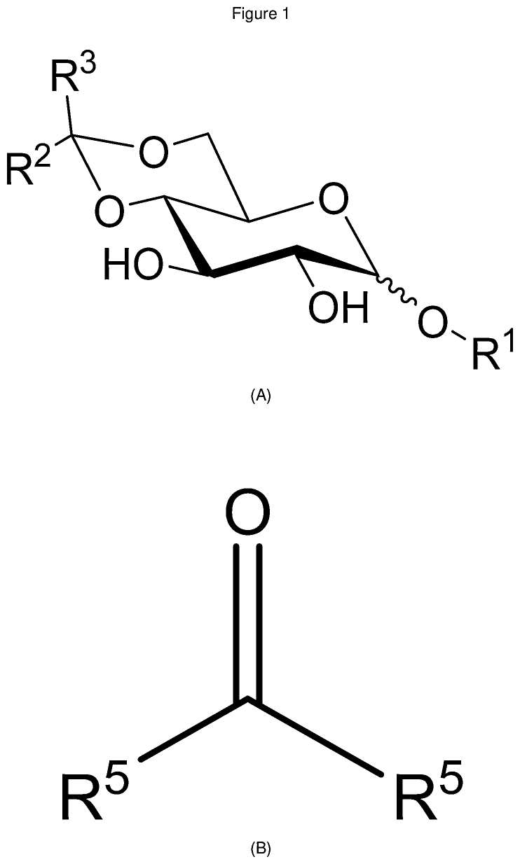

The present invention relates to a polymer derived from monomers (A) and (B) (see FIG. 1):

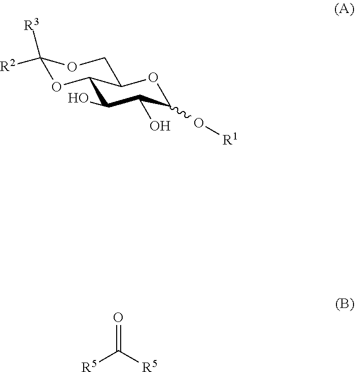

wherein
R¹ is at each occurrence hydrocarbyl with 1 to 40, preferably 1 to 25, C atoms that is optionally substituted and optionally comprises one or more hetero atoms;
R² is at each occurrence H, or hydrocarbyl with 1 to 40, preferably 1 to 25, C atoms that is optionally substituted and optionally comprises one or more hetero atoms;
R³ is at each occurrence H, or hydrocarbyl with 1 to 40, preferably 1 to 25, C atoms that is optionally substituted and optionally comprises one or more hetero atoms;
R⁵ is a leaving group, preferably selected from halogen, imidazole, —OR⁴, —SR⁴, or —N(R⁴)₂;
R⁴ is hydrocarbyl with 1 to 40 C atoms that is optionally substituted and optionally comprises one or more hetero atoms;
each R⁴ may be the same or different,
each R⁵ may be the same or different, preferably the same.

It will be clear to a person skilled in the art that a polymer derived from monomers (A) and (B) is a polycarbonate. Monomer (A) has two hydroxyl groups: one on the carbon atom designated in the art as the 2-carbon atom and the other on the carbon atom designated in the art as the 3-carbon atom. Each of the two hydroxyl groups of monomer (A) may act as a nucleophile. The 2-hydroxyl may therefore form a bond to an electrophilic carbonyl of one monomer (B) and the 3-hydroxyl may therefore form a bond to an electrophilic carbonyl of another monomer (B). Monomer (B) is an electrophilic carbonyl with two leaving groups, R⁵. Monomer (B) may therefore react with two different monomers (A). As each monomer (A) may react with two monomers (B), and as each monomer (B) may react with two monomers (A), the formation of a polymer is permitted.

As the polymer derived from monomers (A) and (B) is derived from more than one species of monomer (i.e. monomer (A) and monomer (B)), a person skilled in the art will recognize that the polymer derived from monomers (A) and (B) is a copolymer as defined herein.

Preferably, monomer (A) is:

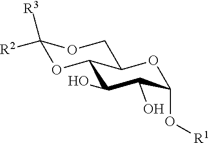

Preferably, monomer (A) is LMG, CMG, BMG, EMG, CAG, or EEG, more preferably LMG, EEG, or CAG.

Preferably, monomer (B) is a common carbonylation agent. Preferably, monomer (B) is a dialkyl carbonate, a diaryl carbonate, diphenyl carbonate, phosgene, triphosgene, or carbonyldiimidazole. Preferably, monomer (B) is a dialkyl carbonate, for example dicarbonate of a C₁-C₂₀ alkyl, more preferably a C₁-C₁₂ alkyl, still more preferably a C₁-C₆ alkyl, more preferably a C₁-C₄ alkyl, wherein each alkyl in the dicarbonate may be the same or different, preferably the same.

The present invention also relates to a polymer comprising a repeat unit of formula (I) and at least one terminal group of formula (II):

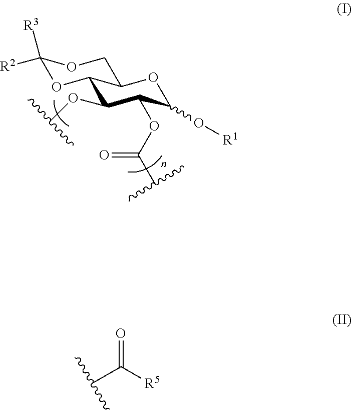

wherein
R¹-R⁵ are as hereinbefore defined;
n is an integer from 2 to 200; and
at least one terminal group of formula (II) is derived from a monomer of the polymer.

Preferably, the at least one terminal group of formula (II) is not derived from a polymerization initiator. Preferably, neither of the terminal groups of the polymers of the present invention are derived from a polymerization initiator.

Preferably, the at least one terminal group of formula (II) is not derived from solvent. In other words, preferably the at least one terminal group of formula (II) is not derived from a molecule of solvent or a solvent molecule. Preferably, neither of the terminal groups of the polymers of the present invention are derived from solvent.

Preferably, the at least one terminal group of formula (II) is not derived from a catalyst. In other words, preferably the at least one terminal group of formula (II) is not derived from a molecule of catalyst or a catalyst molecule. Preferably, neither of the terminal groups of the polymers of the present invention are derived from catalyst.

Preferably, in the at least one terminal group of formula (II), R⁵ is not-O-methylbenzyl, more preferably not —O-4-methylbenzyl. Preferably, in the at least one terminal group of formula (II), R⁵ is not:

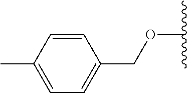 [SMILES: *OCc1ccc(C)cc1]

Preferably, in the at least one terminal group of formula (II), R⁵ is not derived from triazabicyclodecene (TBD). Preferably, in the at least one terminal group of formula (II), R⁵ is not:

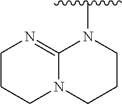 [SMILES: *N1CCCN2CCCN=C12]

Preferably, the repeat unit of formula (I) is:

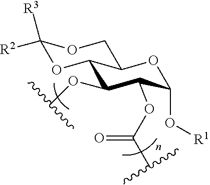

As demonstrated in the Examples section, a polymer comprising a repeat unit of formula (I) and at least one terminal group of formula (II) may be derived from monomers (A) and (B).

Preferably, the polymers of the present invention are derived from monomers (A) and (B) and comprise a repeat unit of formula (I).

Preferably, the polymers of the present invention are derived from monomers (A) and (B) and comprise at least one terminal group of formula (II), wherein the at least one terminal group of formula (II) is derived from a monomer of the polymer.

Preferably, the polymers of the present invention are derived from monomers (A) and (B) and comprise a repeat unit of formula (I) and at least one terminal group of formula (II), wherein the at least one terminal group of formula (II) is derived from a monomer of the polymer.

Preferably, the polymer of the present invention is derived from the step-growth polymerization of monomers (A) and (B).

Preferably, the polymers of the present invention are derived from the condensation polymerization of monomers (A) and (B). It will be clear to a person skilled in the art that each step in the condensation polymerization of monomers (A) and (B) proceeds by the condensation, or loss, of a molecule of formula H—R⁵.

Preferably, the polymers of the present invention are not derived from the chain-growth polymerization of monomers (A) and (B). Preferably, the polymers of the present invention are not derived from the addition polymerization of monomers (A) and (B). Preferably, the polymer of the polymers of the present invention are not derived from the ring-opening polymerization of monomers (A) and (B).

Preferably, the polymers of the present invention are condensation polymers.

Preferably, the polymers of the present invention are step-growth polymers.

Preferably, the polymers of the present invention are copolymers.

Preferably, the polymers of the present invention are not chain-growth polymers. In other words, preferably the polymers of the present invention are not derived from a chain-growth polymerization.

Preferably, the polymers of the present invention are not addition polymers. In other words, preferably the polymers of the present invention are not derived from an addition polymerization.

Preferably the polymers of the present invention are not derived from a ring-opening polymerization.

Preferably, the polymers of the present invention are linear polymers.

Preferably, both terminal groups of the polymers of the present invention may be the same or different, preferably the same.

Preferably, the polymers of the present invention have a backbone consisting of a repeat unit of formula (I).

Preferably, the polymers of the present invention are of formula (Ia), (Ib), or (Ic):

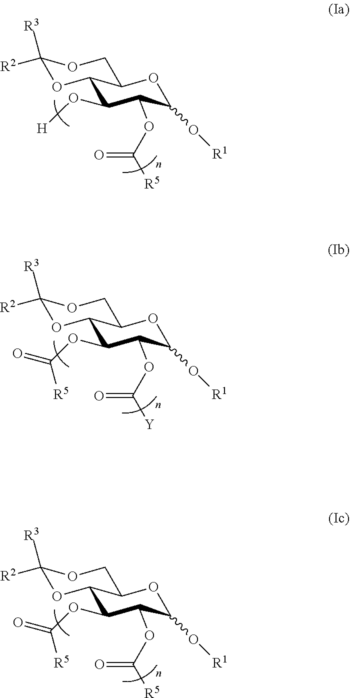

wherein Y is selected from:

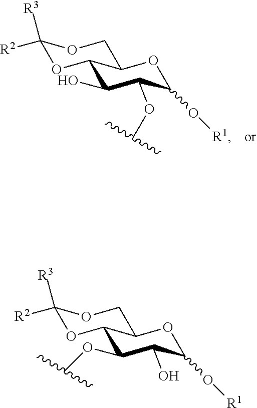

Preferably, the polymers of the present invention are of formula (Id), (Ie), or (If):

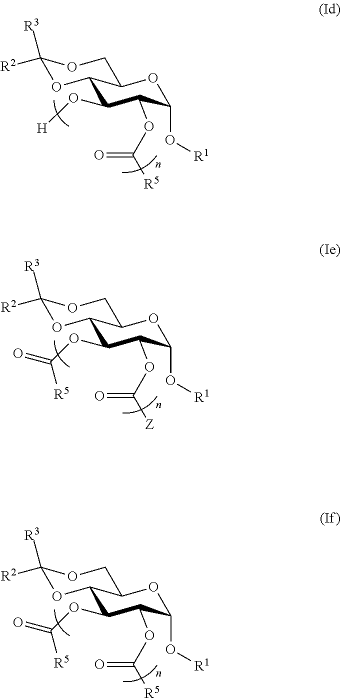

wherein Z is selected from:

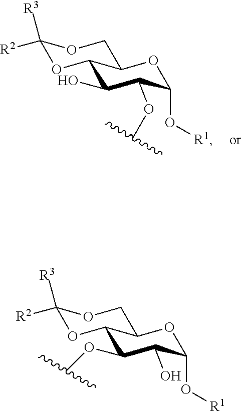

Preferably, the polymers of the present invention are PLMG, PCMG, PBMG, PEMG, or PEEG (as defined in Table 2).

In any aspect of the present invention, preferably the stereochemistry at the C1 position of a sugar is alpha.

In any aspect of the present invention, preferably R¹ is independently selected from hydrocarbyl having 1 to 25 C atoms, more preferably 1 to 20 C atoms, still more preferably 1 to 15 C atoms, yet more preferably 2 to 11 C atoms.

In any aspect of the present invention, preferably R²⁻⁴ are independently of each other selected from hydrocarbyl having 1 to 25 C atoms, more preferably 1 to 20 C atoms, still more preferably 1 to 15 C atoms, yet more preferably 2 to 11 C atoms.

In any aspect of the present invention, preferably R¹ is selected from straight-chain or branched-chain C₁-C₂₀ alkyl, C₂-C₂₀ alkenyl, C₂-C₂₀ alkynyl, or C₅-C₂₀ aryl, each of which is optionally substituted.

In any aspect of the present invention, preferably R¹ is C₁-C₂₀ alkyl, more preferably C₁-C₁₁ alkyl, still more preferably C₁-C₆ alkyl, yet more preferably C₂-C₄ alkyl.

In any aspect of the present invention, preferably R¹ is C₂-C₂₀ alkenyl, more preferably C₂-C₁₂ alkenyl, still more preferably C₂-C₈ alkenyl, yet more preferably C₂-C₆ alkenyl.

In any aspect of the present invention, preferably R¹ is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R¹ is C₅-C₂₀ aryl, more preferably C₅-C₁₂ aryl, still more preferably C₆-C₁₀ aryl, yet more preferably C₆-C₈ aryl.

In any aspect of the present invention, preferably R¹ is methyl, ethyl, butyl, crotyl or allyl. Yet more preferably, R¹ is methyl, ethyl, or allyl.

In any aspect of the present invention, preferably R²⁻³ are independently of each other selected from H, straight-chain or branched-chain C₁-C₂₀ alkyl, C₂-C₂₀ alkenyl, C₂-C₂₀ alkynyl, or C₅-C₂₀ aryl, each of which is optionally substituted.

In any aspect of the present invention, preferably R² is selected from straight-chain or branched-chain C₁-C₂₀ alkyl, C₂-C₂₀ alkenyl, C₂-C₂₀ alkynyl, or C₅-C₂₀ aryl, each of which is optionally substituted.

In any aspect of the present invention, preferably R² is C₁-C₂₀ alkyl, more preferably C₁-C₁₁ alkyl, still more preferably C₁-C₆ alkyl, yet more preferably C₂-C₄ alkyl.

In any aspect of the present invention, preferably R² is C₂-C₂₀ alkenyl, more preferably C₂-C₁₂ alkenyl, still more preferably C₂-C₈ alkenyl, yet more preferably C₂-C₆ alkenyl.

In any aspect of the present invention, preferably R² is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R² is C₅-C₂₀ aryl, more preferably C₅-C₁₂ aryl, still more preferably C₆-C₁₀ aryl, yet more preferably C₆-C₈ aryl.

In any aspect of the present invention, preferably R² is H, phenyl, C₁-C₂₀-alkyl, or styrenyl.

In any aspect of the present invention, preferably R³ is selected from straight-chain or branched-chain C₁-C₂₀ alkyl, C₂-C₂₀ alkenyl, C₂-C₂₀ alkynyl, or C₅-C₂₀ aryl, each of which is optionally substituted.

In any aspect of the present invention, preferably R³ is C₁-C₂₀ alkyl, more preferably C₁-C₁₁ alkyl, still more preferably C₁-C₆ alkyl, yet more preferably C₂-C₄ alkyl.

In any aspect of the present invention, preferably R³ is C₂-C₂₀ alkenyl, more preferably C₂-C₁₂ alkenyl, still more preferably C₂-C₅ alkenyl, yet more preferably C₂-C₆ alkenyl.

In any aspect of the present invention, preferably R³ is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R³ is C₅-C₂₀ aryl, more preferably C₅-C₁₂ aryl, still more preferably C₆-C₁₀ aryl, yet more preferably C₆-C₈ aryl.

In any aspect of the present invention, preferably R³ is H, phenyl, C₁-C₂₀-alkyl, or styrenyl.

In any aspect of the present invention, preferably R³ is H, phenyl, C₁-C₂₀-alkyl, or styrenyl.

In any aspect of the present invention, preferably at least one of R² and R³ is H. More preferably, R³ is H.

In any aspect of the present invention, preferably at least one of R² and R³ is not H. More preferably, R² is not H.

In any aspect of the present invention, preferably R⁵ is halogen, imidazole, —OR⁴, —SR⁴, or —N(R⁴)₂. More preferably, R⁵ is halogen or —OR⁴. Still more preferably, R⁵ is —OR⁴.

In any aspect of the present invention, preferably each R⁵ is the same.

In any aspect of the present invention, preferably R⁴ is selected from straight-chain or branched-chain C₁-C₂₀ alkyl, C₂-C₂₀ alkenyl, C₂-C₂₀ alkynyl, or C₅-C₂₀ aryl, each of which is optionally substituted, more preferably R⁴ is straight-chain or branched-chain C₁-C₂₀ alkyl or C₅-C₂₀ aryl.

In any aspect of the present invention, preferably R⁴ is C₁-C₂₀ alkyl, more preferably C₁-C₁₁ alkyl, still more preferably C₁-C₆ alkyl, yet more preferably C₁-C₄ alkyl.

In any aspect of the present invention, preferably R⁴ is C₂-C₂₀ alkenyl, more preferably C₂-C₁₂ alkenyl, still more preferably C₂-C₅ alkenyl, yet more preferably C₂-C₆ alkenyl.

In any aspect of the present invention, preferably R⁴ is C₂-C₂₀ alkynyl, more preferably C₂-C₁₂ alkynyl, still more preferably C₂-C₆ alkynyl, yet more preferably C₂-C₄ alkynyl.

In any aspect of the present invention, preferably R⁴ is C₅-C₂₀ aryl, more preferably C₅-C₁₂ aryl, still more preferably C₆-C₁₀ aryl, yet more preferably C₆-C₈ aryl.

In any aspect of the present invention, preferably R⁴ is phenyl or methyl, more preferably phenyl.

In any aspect of the present invention, preferably R⁴ is perhaloalkyl, more preferably perfluoroalkyl or perchloroalkyl. In any aspect of the present invention, preferably R⁴ is trihalomethyl, preferably trifluoromethyl or trichloromethyl.

Preferably, in the polymers of the present invention at least one of R¹, R², or R³ comprises an alkene functional group. Advantageously, such a functional group readily enables post-polymerization modification of the polymers of the present invention. For example, such a functional group may permit the performance of cross-linking reactions between different polymer macromolecules. Such post-polymerization modification is advantageous as it makes the polymers of the present invention, and their properties, yet more “tuneable”.

In any aspect of the present invention, preferably n is 2 to 200, more preferably 5 to 100, still more preferably 10 to 50.

Examples of alkyl groups which may be used in any aspect of the present invention include straight-chain alkyl groups such as methyl, ethyl, n-propyl, n-butyl, and their analogues with higher carbon numbers, such as —C₁₁H₂₃. Further examples of alkyl groups which may be used in any aspect of the present invention include branched-chain alkyl groups such as iso-propyl, sec-butyl, iso-butyl, tert-butyl, and their analogues with higher carbon numbers. Further examples of alkyl groups which may be used in any aspect of the present invention include cycloalkyl groups such as cyclopropyl, cyclobutyl, cyclopentyl, cyclohexyl, and their analogues with higher carbon numbers. Cycloalkyl groups may be monocyclic or polycyclic, such as bicyclic.

Alkyl groups of any aspect of the present invention may be substituted or unsubstituted at any position. Alkyl groups in any aspect of the present invention may optionally comprise one or more heteroatoms, either in the main chain or in a branch. For example, alkyl groups in any aspect of the present invention may comprise one or more ether or thioether functionalities, either in the main chain or in a branch.

Examples of alkylene groups which may be used in any aspect of the present invention include alkylene groups notionally derived from the removal of a hydrogen atom from an sp² carbon, such as vinyl and its analogues with higher carbon numbers. Further examples of alkylene groups which may be used in any aspect of the present invention include alkylene groups notionally derived from the removal of a hydrogen atom from an sp³ carbon, such as allyl, crotyl, and their analogues with higher carbon numbers.

Alkylene groups of any aspect of the present invention may be substituted or unsubstituted at any position, whether at an sp² carbon, such as styrenyl and its derivatives and analogues, or at an sp³ carbon. Alkylene groups of any aspect of the present invention may optionally comprise one or more heteroatoms, either in the main chain or in a branch.

Examples of alkynyl groups which may be used in any aspect of the present invention include alkynyl notionally derived from the removal of a hydrogen atom from an sp² carbon, such as ethynyl and its analogues with higher carbon numbers. Further examples of alkynyl groups which may be used in any aspect of the present invention include alkynyl groups notionally derived from the removal of a hydrogen atom from an sp³ carbon, such as propargyl, 2-butynyl, and their analogues with higher carbon numbers.

Alkynyl groups in any aspect of the present invention may be substituted or unsubstituted at any position. Alkynyl groups in any aspect of the present invention may optionally comprise one or more heteroatoms, either in the main chain or in a branch.

Examples of aryl groups which may be used in any aspect of the present invention include monocyclic aryl groups, such as phenyl, and polycyclic aryl groups, such as naphthyl. Aryl groups in any aspect of the present invention also include heteroaryl groups comprising one or more heteroatoms, such as heteroaryl groups derived from, for example, furan, pyrrole, pyridine, thiophene, benzofuran, indole, imidazole and benzimidazole.

Aryl groups in any aspect of the present invention may be substituted or unsubstituted at any position. For example, substituted aryl groups in any aspect of the present invention may be substituted at any position on the aromatic ring, either with electron-donating or, preferably, with electron-withdrawing groups, such as —NO₂, —CN, or —CF₃.

Any hydrocarbyl group (e.g. alkyl, alkenyl, alkynyl, aryl, etc.) used in any aspect of the present invention may be substituted or unsubstituted. For example, substitution may be with an alkyl group, an alkylene group, an alkynyl group, an aryl group, a halogen, —NO₂, CN, an ether group (such as an alkoxy group), a thioether group, or sulphate groups, wherein each of these groups may themselves be substituted or unsubstituted. Preferably, substitutions in the present invention are not with an unprotected nucleophilic group.

Preferably, substitutions in the present invention are not with a carbonyl, or carbonyl-containing, group.

Preferably, hydrocarbyl groups in any aspect of the present invention do not comprise an unprotected nucleophilic group. Preferably, hydrocarbyl groups in any aspect of the present invention do not comprise a carbonyl, or carbonyl-containing, group.

Preferably, the polymers of the present invention have an Mₙ of greater than 0.5 kDa, such as 0.5 to 50 kDa. Preferably, the polymers of the present invention have an Mₙ of 1 to 50 kDa, more preferably 2 to 25 kDa.

Preferably, the polymers of the present invention have an M_{w} of greater than 0.5 kDa, such as 0.5 to 100 kDa. Preferably, the polymers of the present invention have an M_{w} of 1 to 100 kDa, more preferably 5 to 50 kDa.

Preferably, the polymers of the present invention have an Mₚ of greater than 0.5 kDa, such as 0.5 to 75 kDa. Preferably, the polymers of the present invention have an Mₚ of 1 to 75 kDa, more preferably 3 to 35 kDa.

Preferably, the polymers of the present invention have a dispersity of 1 to 10, preferably 1 to 5, more preferably 1 to 3, still more preferably 1.2 to 2.5, yet more preferably 1.3 to 2.2.

Preferably, the polymers of the present invention have a dispersity of 1 to 3, more preferably 1.2 to 2.5, still more preferably 1.3 to 2.2.

Preferably, the polymers of the present invention have a T_{d} of greater than 200° C., more preferably greater than 220° C., still more preferably greater than 270° C.

Preferably, the polymers of the present invention are amorphous polymers. Alternatively, the polymers of the present invention are preferably crystalline or semi-crystalline polymers.

Preferably, the polymers of the present invention have a T_{g} of 0 to 100° C., more preferably 20 to 80° C., still more preferably 30 to 60° C. Alternatively, the polymers of the present invention have a T_{g} of 75 to 250° C., more preferably 100 to 200° C., still more preferably 125 to 190° C.

Preferably, the polymers of the present invention have a water contact angle at t=0 s of 30 to 125°. Preferably, the polymers of the present invention have a contact angle at t=0 s, of 30 to 90°, more preferably 40 to 80°, still more preferably 50 to 75°. Alternatively, the polymers of the present invention have a contact angle at t=0 s, of 50 to 125°, preferably 70 to 115°, more preferably 90 to 110°.

Preferably, the polymers of the present invention have a water contact angle at t=240 s, of 10 to 125°. Preferably, the polymers of the present invention have a contact angle at t=240 s, of 10 to 50°, more preferably 20 to 40°, still more preferably 25 to 35°. Alternatively, the polymers of the present invention have a contact angle at t=240 s, of 30 to 90°, more preferably 40 to 80°, still more preferably 50 to 75°.

Advantageously, the polymers of the present invention have a desirable diversity of molar mass, thermal, and contact angle properties. The range of polymer parameters that are achievable mean that the polymers of the invention are “tuneable”, i.e. that the polymers can advantageously provide a range of chemical, thermal, degradation and mechanical properties, meaning they can be exploited in a diverse range of end-applications.

Preferably, the polymers of the present invention are degradable, more preferably biodegradable. Advantageously, this reduces the negative impact associated with plastic disposal.

Preferably, the polymers of the present invention undergo hydrolytic degradation under acidic aqueous conditions (e.g. 1 M HCl) at ambient temperature over a period of 30 days to 180 days.

Preferably, the polymers of the present invention undergo hydrolytic degradation under basic aqueous conditions (e.g. 1 M NaOH) at ambient temperature over a period of 30 days to 180 days.

Preferably, the polymers of the present invention undergo degradation under enzymatic aqueous conditions at ambient temperature over a period of 30 days to 365 days.

Preferably, the polymers of the present invention undergo degradation under microbial conditions at ambient temperature over a period of 30 days to 365 days.

Preferably, the polymers of the present invention undergo degradation meeting the OECD 310 standard. This test is considered the “gold standard” for assessing the impact of polymers in a waste water environment or water treatment plant, and it is highly beneficial for use in certain applications that the polymers of the invention satisfy this test.

The present invention also relates to process for preparing a polymer of the present invention, wherein said process is a condensation polymerization. Preferably, the process is a step-growth polymerization.

Preferably, the process comprises reacting a compound of formula (A) with a compound of formula (B)

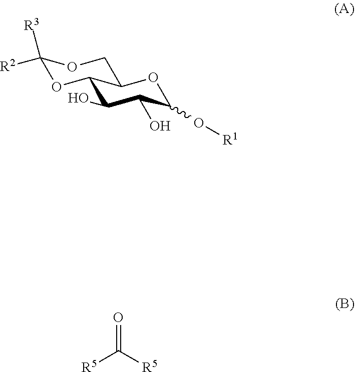

wherein R¹, R², R³, and R⁵ are as hereinbefore described. In formula (B), each R⁵ may be the same or different, preferably the same.

The skilled person will recognise that reacting a compound of formula (A) with a compound of formula (B) will yield the following products:

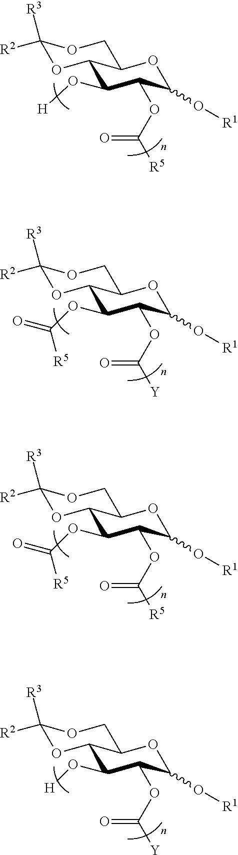

wherein Y is selected from:

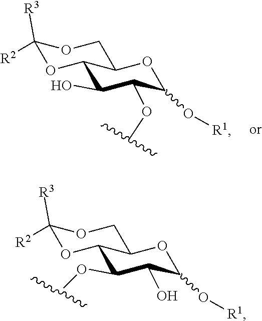

Preferably, monomer (A) is LMG, CMG, BMG, EMG, CAG, or EEG, more preferably LMG, EEG, or CAG.

Preferably, compound (B) is a common carbonylation agent. Preferably, compound (B) is a dialkyl carbonate, a diaryl carbonate, diphenyl carbonate, phosgene, triphosgene, or carbonyldiimidazole. Preferably, compound (B) is a dialkyl carbonate, for example a dicarbonate of a C₁-C₂₀ alkyl, more preferably a C₁-C₁₂ alkyl, still more preferably a C₁-C₆ alkyl, and yet more preferably a C₂-C₆ alkyl, wherein each alkyl in the dicarbonate may be the same or different, preferably the same.

Preferably, the process comprises a step of mixing and heating a compound of formula (A) with a compound of formula (B), optionally under positive nitrogen flow. Preferably, the process comprises a further step of placing the system under vacuum, preferably occurring after a step of mixing and heating a compound of formula (A) with a compound of formula (B), optionally under positive nitrogen flow.

Preferably, the process comprises the removal of a condensate. Preferably, the condensate is of the formula H—R⁵.

Preferably, the process comprises the use of a catalyst.

Preferably, the process comprises the use of an acidic catalyst. Example acidic catalysts include Lewis acids, Brønsted-Lowry acids, hydrogen halide acids, sulphuric acids, nitric acids, phosphoric acids, and organic acids, such as carboxylic acids and sulfonic acids.

Preferably, the process comprises the use of a basic catalyst. Example basic catalysts include Lewis bases, Brønsted-Lowry bases, metal hydroxides, such as Group 1 or Group 2 metal hydroxides, metal carbonates, such as Group 1 or Group 2 metal carbonates, organometallic catalysts, and amines.

Preferably, the process comprises the use of an organometallic catalyst, more preferably an organolithium catalyst, still more preferably Li (AcAc).

Preferably, the process is not a chain growth polymerization. Preferably, the process is not an addition polymerization.

The present invention also relates to a polymer obtained or obtainable by the process. Preferably, the polymers of the present invention are obtainable, preferably obtained, by the process hereinbefore described.

The present invention also provides a method for preparing a deprotected polymer, the method comprising reacting, preferably deprotecting, a polymer of the present invention to give a deprotected polymer comprising a repeat unit of formula (Ii) and at least one terminal group of formula (II):

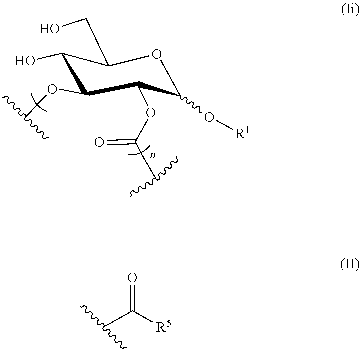

wherein R¹, R⁵, and n are as hereinbefore described; and
the at least one terminal group of formula (II) is derived from a monomer of the polymer.

Preferably the method comprises acid-catalyzed hydrolysis, preferably employing a strong acid. Examples acids include Brønsted-Lowry acids, hydrogen halide acids, sulphuric acids, nitric acids, phosphoric acids, and organic acids, such as carboxylic acids and sulfonic acids.

Preferably, the acid is an organic acid, more preferably a fluorinated acid or a sulfonic acid, still more preferably TsOH or TFA.

Preferably the method comprises hydrogenolysis, more preferably wherein said hydrogenolysis involves a catalytic hydrogenation.

Preferably, the method is a deprotection. This is explained in that (Ii) is related to (I) by the removal of an acetal protecting group.

Preferably, the deprotection is complete. In other words: preferably the method gives a polymer comprising no units or repeat units of formula (I).

Alternatively, the deprotection is preferably partial. In other words: preferably the method gives a polymer comprising repeat units of formula (I) as well as repeat units of formula (Ii).

Preferably, the method gives a polymer wherein the molar ratio of repeat units of formula (I) to repeat units of formula (Ii) is 0:1 to 1:0, more preferably 0:1 to 0.5:0.5, still more preferably 0.05:0.95 to 0.35:0.65, yet more preferably 0.1:0.9 to 0.2:0.8. Preferably, the molar ratio of repeat units of formula (I) to repeat units of formula (Ii) is 0:1 to 1:0, more preferably 0.25:0.75 to 0.75:0.25, still more preferably 0.35:0.65 to 0.65:0.35, yet more preferably 0.4:0.6 to 0.6:0.4. Preferably, the molar ratio of repeat units of formula (Ii) to repeat units of formula (I) is 0:1 to 1:0, more preferably 0:1 to 0.5:0.5, still more preferably 0.05:0.95 to 0.35:0.65, yet more preferably 0.1:0.9 to 0.2:0.8. Preferably, the molar ratio of repeat units of formula (I) to repeat units of formula (Ii) is 0:1.

The degree of deprotection in the method can be controlled by the skilled person. For example, when the method comprises reacting with acid, controlling the strength of the acid, the concentration of the acid, and/or the reaction time and temperature may be illustrative means of controlling the degree of deprotection. Removing reaction products may also favour a greater degree of deprotection.

Preferably, the method comprises:
(i) preparing a polymer of the present invention (preferred processes and polymers are as hereinbefore described)
(ii) reacting, preferably deprotecting, a polymer of the present invention to give a deprotected polymer comprising a repeat unit of formula (Ii) and at least one terminal group of formula (II):

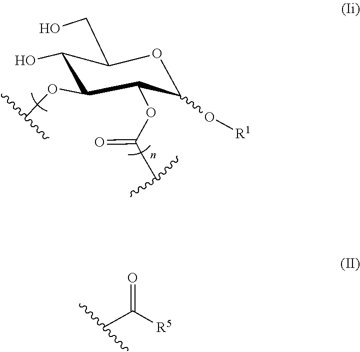

wherein R¹, R⁵, and n are as hereinbefore described; and
the at least one terminal group of formula (II) is derived from a monomer of the polymer (preferred methods are as hereinbefore described).

The present invention also relates to a deprotected polymer obtained or obtainable by the method of the present invention for preparing a deprotected polymer hereinbefore described.

The present invention also relates to a deprotected polymer comprising a repeat unit of formula (Ii) and at least one terminal group of formula (II):

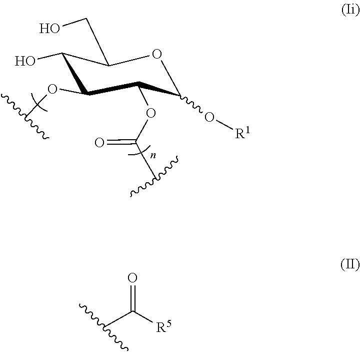

wherein R¹, R⁵ and n are as hereinbefore defined; and
the terminal group of formula (II) is derived from a monomer of the polymer.

Preferably, the deprotected polymer of the present invention does not comprise repeat units of formula (I). Alternatively, preferably the deprotected polymer of the present invention further comprises repeat units of formula (I).

Preferably, in the deprotected polymer of the present invention the molar ratio of repeat units of formula (I) to repeat units of formula (Ii) is 0:1 to 1:0, more preferably 0:1 to 0.5:0.5, still more preferably 0.05:0.95 to 0.35:0.65, yet more preferably 0.1:0.9 to 0.2:0.8. Preferably, the molar ratio of repeat units of formula (I) to repeat units of formula (Ii) is 0:1 to 1:0, more preferably 0.25:0.75 to 0.75:0.25, still more preferably 0.35:0.65 to 0.65:0.35, yet more preferably 0.4:0.6 to 0.6:0.4. Preferably, the molar ratio of repeat units of formula (Ii) to repeat units of formula (I) is 0:1 to 1:0, more preferably 0:1 to 0.5:0.5, still more preferably 0.05:0.95 to 0.35:0.65, yet more preferably 0.1:0.9 to 0.2:0.8. Preferably, the molar ratio of repeat units of formula (I) to repeat units of formula (Ii) is 0:1.

Preferably, the at least one terminal group of formula (II) is not derived from a polymerization initiator. Preferably, neither of the terminal groups of the deprotected polymer of the present invention are derived from a polymerization initiator.

Preferably, the at least one terminal group of formula (II) is not derived from solvent. In other words, preferably the at least one terminal group of formula (II) is not derived from a molecule of solvent or a solvent molecule. Preferably, neither of the terminal groups of the deprotected polymer of the present invention are derived from solvent.

Preferably, the at least one terminal group of formula (II) is not derived from a catalyst. In other words, preferably the at least one terminal group of formula (II) is not derived from a molecule of catalyst or a catalyst molecule. Preferably, neither of the terminal groups of the deprotected polymer of the present invention are derived from catalyst.

Preferably, in the at least one terminal group of formula (II), R⁵ is not-O-methylbenzyl, more preferably not —O-4-methylbenzyl. Preferably, in the at least one terminal group of formula (II), R⁵ is not:

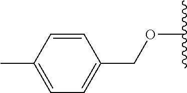 [SMILES: *OCc1ccc(C)cc1]

Preferably, in the at least one terminal group of formula (II), R⁵ is not derived from 1,5,7-triazabicyclo[4.4.0]dec-5-ene (TBD). Preferably, in the at least one terminal group of formula (II), R⁵ is not:

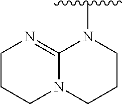 [SMILES: *N1CCCN2CCCN=C12]

Preferably, the repeat unit of formula (Ii) is:

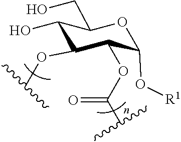

Both terminal groups of the deprotected polymer of the present invention may be the same or different, preferably the same.

Preferably, the deprotected polymer of the present invention has a backbone consisting of a repeat unit of formula (Ii).

Preferably, the deprotected polymer of the present invention is of formula (Iia), (Iib), or (Iic):

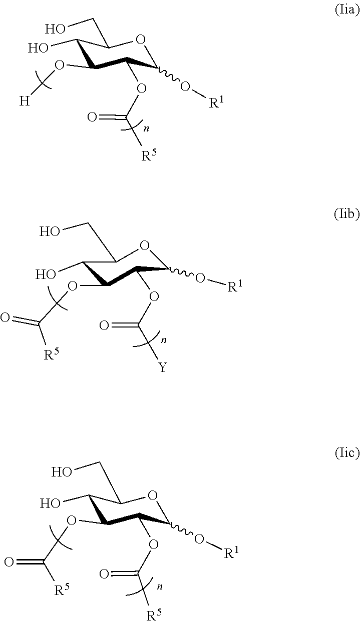

Wherein Y is selected from:

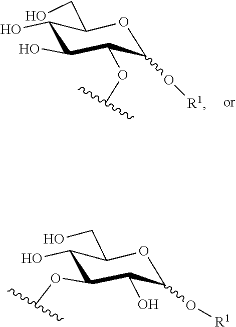

Preferably, the deprotected polymer of the present invention is of formula (Iid), (Iie), or (Iif):

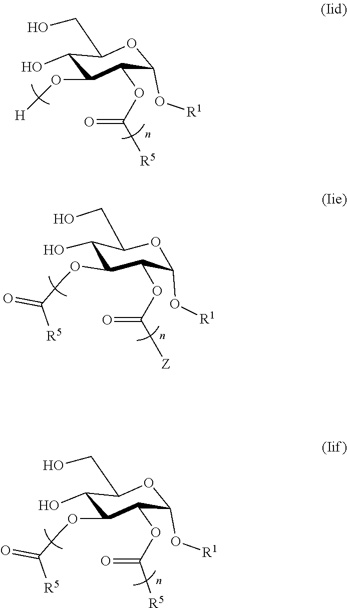

wherein Z is selected from:

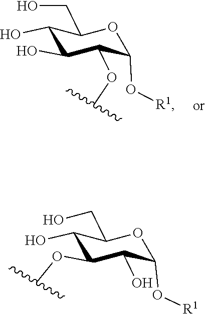

Preferably, the deprotected polymer of the present invention is of formula (Iig), (Iih), or (Iii), more preferably of formula (Iig), (lih), or (Iii):

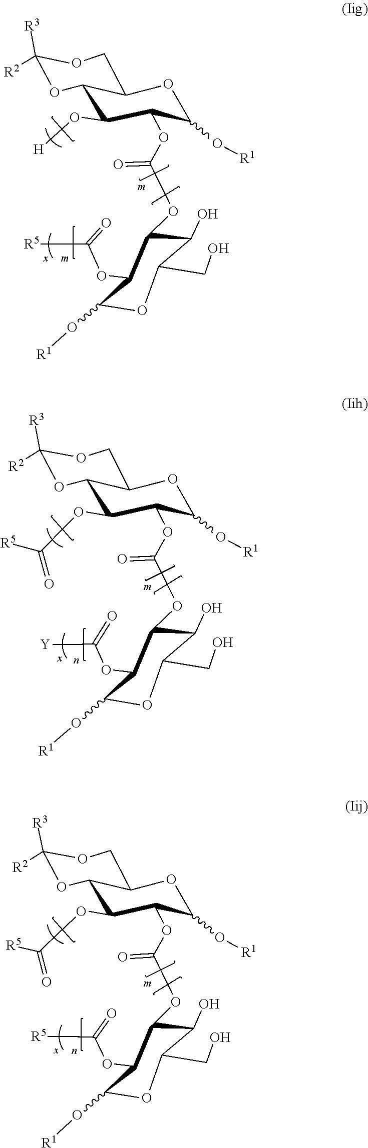

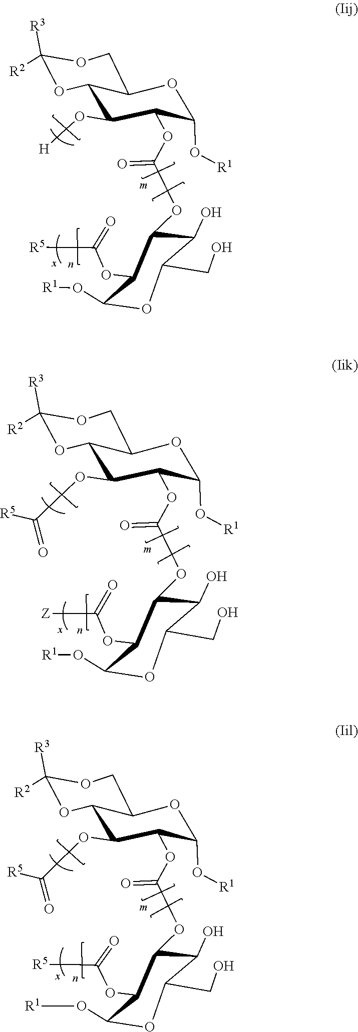

wherein
each R¹ is the same;
x is an integer from 2 to 200;
n and m are independently selected as a fraction between 0 and 1;
n+m=1;
Y is selected from:

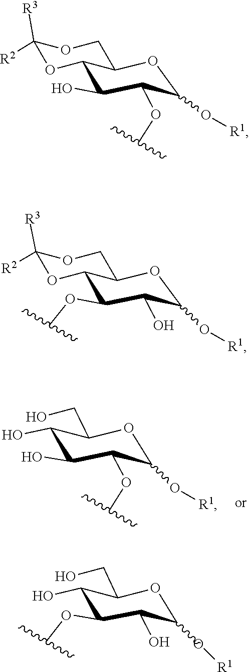

and Z is selected from:

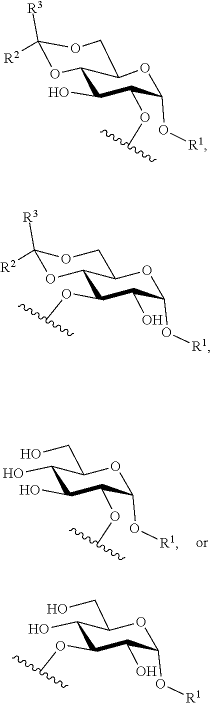

n and m are independently selected as a fraction from 0 to 1, where n+m=1. n therefore represents the proportion units of the type bound by [ ]ₙ in the overall deprotected polymer structure. Similarity, m represents the proportion of units of the type bound by [ ]ₘ in the overall deprotected polymer structure. The overall deprotected polymer structure has a total degree of polymerization x. The number of units of the type bound by [ ]ₙ in the overall deprotected polymer structure is represented by the product of x and n. The number of units of the type bound by [ ]ₘ in the overall deprotected polymer structure is represented by the product of x and m.

In other words, n and m coincide with the molar ratio or percentage of each type of repeat unit in the overall deprotected polymer structure having a total degree of polymerization x.

In formula (Iig) to (Iil), no comment is made on the ordering or connectivity of different repeat units. In other words, formula (Iig) to (Iil) encompass statistical copolymers, random copolymers, block copolymers, and/or alternating copolymers.

Preferably, the deprotected polymer of the present invention has an Mₙ of greater than 0.5 kDa, such as 0.5 to 50 kDa. Preferably, the deprotected polymers of the present invention have an Mₙ of 1 to 50 kDa, more preferably 2 to 25 kDa

Preferably, the deprotected polymer of the present invention has an M_{w} of greater than 0.5 kDa, such as 0.5 to 100 kDa. Preferably, the deprotected polymers of the present invention have an M_{w} of 1 to 100 kDa, more preferably 5 to 50 kDa.

Preferably, the deprotected polymers of the present invention have an Mₚ of greater than 0.5 kDa, such as 0.5 to 75 kDa. Preferably, the deprotected polymers of the present invention have an Mₚ of 1 to 75 kDa, more preferably 3 to 35 kDa.

Preferably, the deprotected polymer of the present invention has a dispersity of 1 to 2, more preferably 1.2 to 1.8, still more preferably 1.35 to 1.65.

Preferably, the deprotected polymer of the present invention has a T_{d} of greater than 200° C., more preferably greater than 240° C., still more preferably greater than 270° C.

Preferably, the deprotected polymer of the present invention has a T_{g} of 100 to 220° C., more preferably 120 to 200° C., still more preferably 150 to 190° C.

Preferably, the deprotected polymer of the present invention has a water contact angle at t=0 s of 15 to 100°, more preferably 15 to 80°, still more preferably 15 to 75°, yet more preferably 15 to 70°.

Preferably, the deprotected polymer of the present invention has a contact angle at t=240 s of 5 to 60°, more preferably 5 to 45°, still more preferably 5 to 40°.

Advantageously, the deprotected polymers of the present invention have a desirable diversity of molar mass, thermal, and contact angle properties. The range of polymer parameters that are achievable mean that the deprotected polymers of the invention are “tuneable”, i.e. that the polymers can advantageously provide a range of chemical, thermal, degradation and mechanical properties, meaning they can be exploited in a diverse range of end-applications.

Preferably, the deprotected polymer of the present invention is degradable, more preferably biodegradable. Advantageously, this reduces the negative impact associated with plastic disposal.

Preferably, the deprotected polymer of the present invention undergoes hydrolytic degradation under acidic aqueous conditions at ambient temperature over a period of 30 days to 180 days.

Preferably, the deprotected polymer of the present invention undergoes hydrolytic degradation under basic aqueous conditions at ambient temperature over a period of 30 days to 180 days.

Preferably, the deprotected polymer of the present invention undergoes degradation under enzymatic aqueous conditions at ambient temperature over a period of 30 days to 365 days.

Preferably, the deprotected polymer of the present invention undergoes degradation under microbial conditions at ambient temperature over a period of 30 days to 365 days.

Preferably, the deprotected polymer of the present invention undergoes degradation meeting the OECD 310 standard.

Preferably, the deprotected polymer of the present invention is PMG.

As demonstrated in the Examples, the deprotected polymer of the present invention is obtainable by the method of the present invention for preparing a deprotected polymer. Preferably, the deprotected polymer of the present invention is obtained or obtainable, preferably obtained, by the method of the present invention for preparing a deprotected polymer.

The present invention also relates to a compound selected from LMG, EEG, and CAG (as defined in Table 1). In these compounds, the stereochemistry at C1 may be alpha or beta. Preferred compounds are LMG, EEG and CAG, wherein the stereochemistry at C1 is a mixture of alpha and beta. Preferred compounds are LMG, EEG and CAG, wherein the stereochemistry at C1 is alpha.

As demonstrated in the Examples, the compounds of the present invention can be prepared from the reaction of glucopyranoside starting materials with aldehydes, ketones, or their protected analogues, such as acetals or ketals. For example, the compounds of the present invention can be prepared according to the following general scheme:

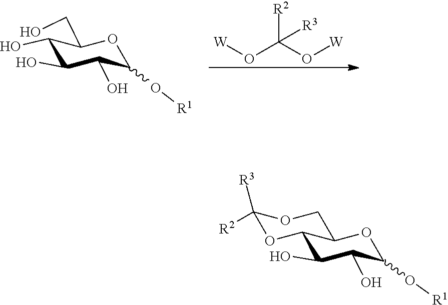

wherein W is a suitable hydrocarbyl group. For example, W may be an alkyl group.

As demonstrated in the Examples, glucopyranoside starting materials can be derived from the hydrolysis of starch. Preferably, this reaction comprises reacting starch with water or alcohol, preferably in the presence of acid, according to the following general scheme:

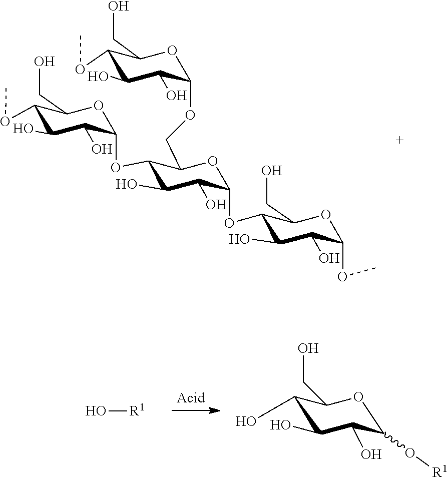

Advantageously, it can therefore be seen that the compounds and/or monomers, and therefore consequently the polymers and deprotected polymers, of the present invention are ultimately derived or derivable from biomass. The present invention therefore provides compounds, polymers, and deprotected polymers which need not be derived from fossil fuel feedstocks, reducing the environmental impact of plastic production.

Advantageously, the processes and methods of the present invention permit a synthetic route from biomass, for example starch, or from starting materials ultimately derived or derivable from biomass, to the compounds, polymers, and deprotected polymers of the present invention. The present invention therefore provides a synthetic route to polymers which minimizes the need for reagents or synthetic steps reliant on fossil fuel feedstocks, reducing the environmental impact of plastic production.

The present invention also relates to a polymer derived from a compound of the present invention.

The present invention also relates to the use of a compound of the present invention to prepare a polymer.

The present invention also relates to the use of a compound of the present invention to prepare a polymer comprising a repeat unit of the following formula:

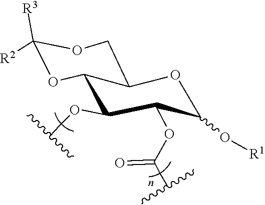

The present invention also relates to the use of a polymer or deprotected polymer of the present invention as a bio-based, sustainable and/or degradable polymer.

The present invention also relates to the use of a polymer or deprotected polymer as hereinbefore described in a personal care product, preferably a cosmetic product, more preferably a skin care product.

The present invention also relates to the use of a polymer or deprotected polymer as hereinbefore described in packaging.

The present invention also relates to the use of a polymer or deprotected polymer of the present invention in a packaging material, in a food product, preferably a gum, and more preferably as a gum base, or in a personal care product, among other possibilities.

### EXAMPLES

### Materials

The starting materials used in the Examples were all obtained from commercial sources, unless specified otherwise.

The monomers used in the examples are summarised in the table below.

TABLE 1

| Structure | Name | Abbreviation | Description |
|---|---|---|---|
| 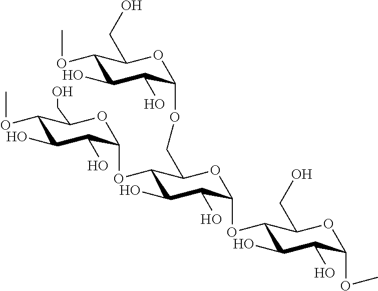 | Starch | — | Natural product |
| 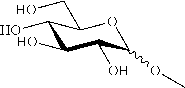 | Methyl D- glucopyranoside | MG | Glucopyranoside starting material |
| 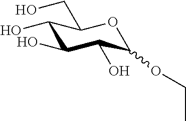 | Ethyl D-glucopyranoside | EG | Glucopyranoside starting material |
| 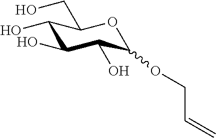 | Allyl D-glucopyranoside | AG | Glucopyranoside starting material |
| 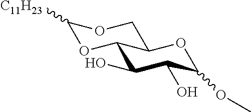 | Methyl 4,6-O-laurylidene- D-glucopyranoside | LMG | Glucopyranoside monomer |
| 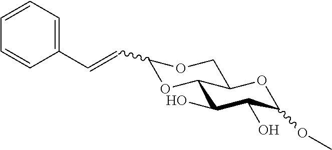 | Methyl 4,6-O- cinnamylidene-D- glucopyranoside | CMG | Glucopyranoside monomer |
| 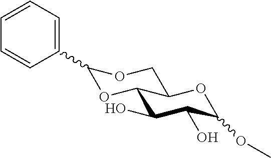 | Methyl 4,6-O- benzylidene-D- glucopyranoside | BMG | Glucopyranoside monomer |
| 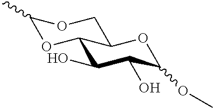 | Methyl 4,6-O-ethylidene- D-glucopyranoside | EMG | Glucopyranoside monomer |
| 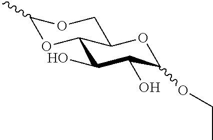 | Ethyl 4,6-O-ethylidene-D- glucopyranoside | EEG | Glucopyranoside monomer |
| 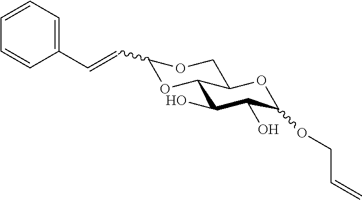 | Allyl 4,6-O- cinnamylidene-D- glucopyranoside | CAG | Glucopyranoside monomer |
| 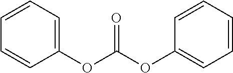 [SMILES: O=C(Oc1ccccc1)Oc1ccccc1] | Diphenyl Carbonate | DPC | Carbonylation agent |
| 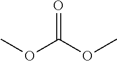 | Dimethyl carbonate | DMC | Carbonylation agent |

### Example 1: Preparation of Glucopyranoside Starting Materials from Starch

Example glucopyranosides were prepared from hydrolysis of starch according to the following procedures.

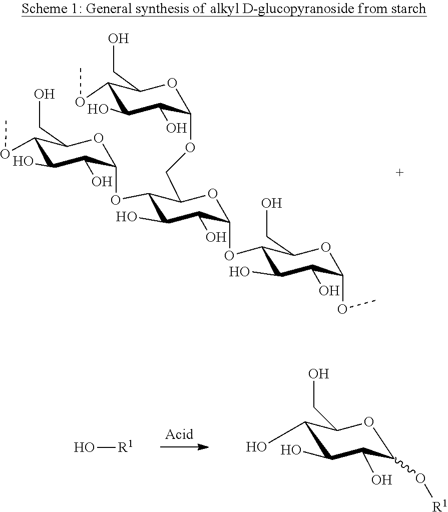

General synthesis of alkyl D-glucopyranoside from starch: To a round bottom flask equipped with a stir bar and condenser was added starch (1 equiv.), alcohol (excess), and acid catalyst (0.01 equiv.). The reaction was stirred at reflux and monitored by TLC. Upon completion, the reaction was cooled to room temperature, the solution was neutralized, any residual solids were removed by filtration, and the products were recovered by removal of the remaining alcohol and drying in vacuo.

Four different reactions were performed, each using a different alcohol. Namely, reactions were performed using ethanol, butanol, allyl alcohol, and crotyl alcohol respectively. The reactions performed and products yielded are displayed below. The products were obtained in a variety of yields.

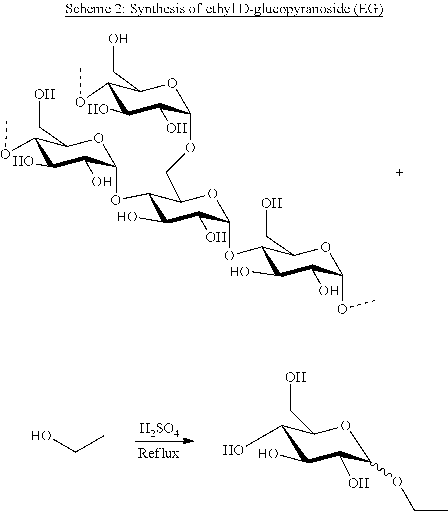

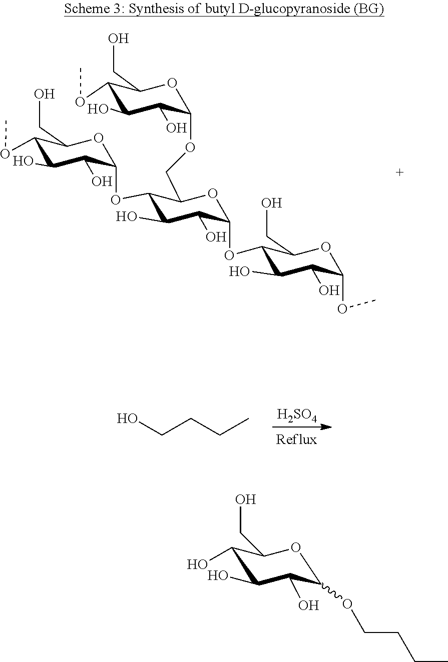

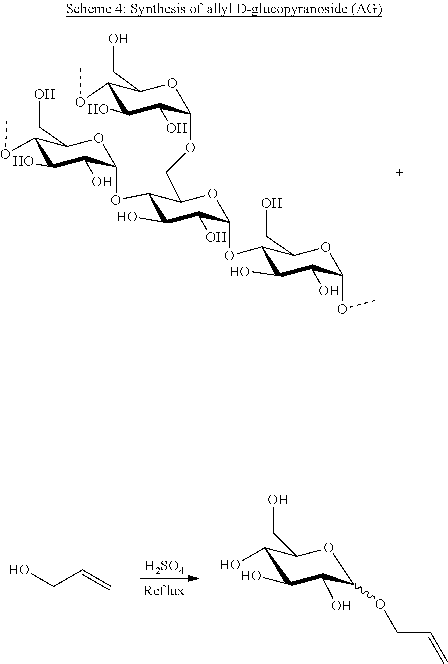

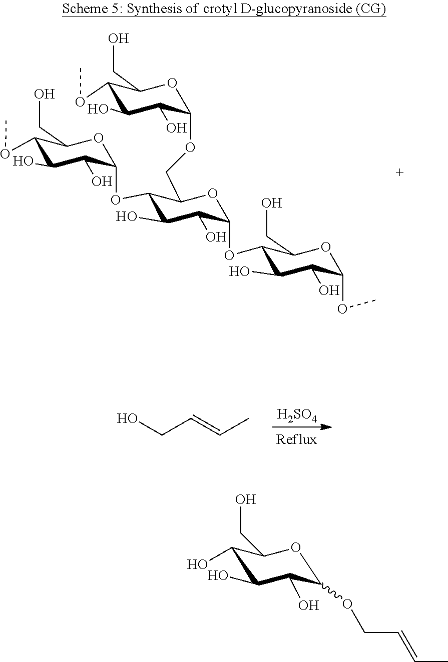

### Example 2: Preparation of Glucopyranoside Monomers

Example glucopyranoside monomers were prepared according to the following procedures. Commercially obtained glucopyranoside starting material was used unless specified otherwise.

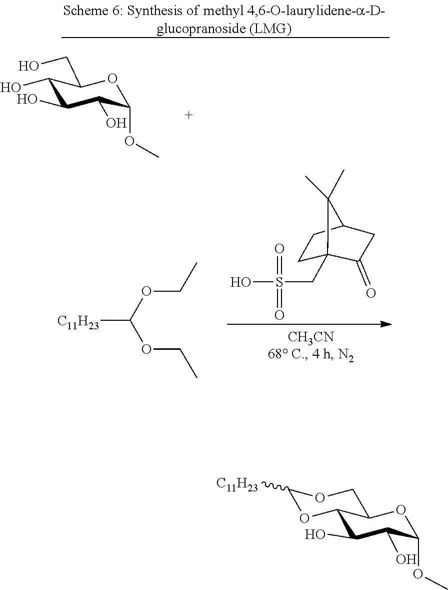

Synthesis of methyl 4,6-O-laurylidene-α-D-glucopyranoside (LMG): To a solution of methyl α-D-glucopyranoside (20.0 g, 103 mmol) in anhydrous acetonitrile (MeCN) (ca. 150 mL) under N₂ was added lauric aldehyde diethyl acetal (34.6 g, 134 mmol) and (1S)-(+)-10-camphorsulfonic acid (120 mg, 0.51 mmol) to obtain a colorless solution with partially insoluble methyl α-D-glucopyranoside. The reaction flask was equipped with a circulating condenser and heated in an oil bath at 68° C. under N₂ for 4 h to obtain a colorless homogeneous solution. The reaction mixture was cooled to room temperature and quenched by addition of 5 mL of saturated KHCO₃ solution (aq.). The solution was concentrated in vacuo and the resulting residue was dissolved in 200 mL of dichloromethane (DCM) and washed with water (150 mL×2) and brine (50 mL). The organic layer was dried over anhydrous Na₂SO₄, filtered, and concentrated to ca. 125 mL in vacuo. The concentrated solution was precipitated into 1.5 L of hexanes and stored in a freezer (−20° C.) overnight, after which the solid was collected by filtration, washed with 750 ml of cold hexanes, and residual solvent was removed in vacuo to give methyl 4,6-O-laurylidene-α-D-glucopyranoside as a colorless solid (32.8 g, 84% yield). ¹H NMR (400 MHZ, CDCl₃) δ 4.75 (d, J=3.9 Hz, 1H), 4.54 (t, J=5.1 Hz, 1H), 4.12 (dd, J=10.2, 4.8 Hz, 1H), 3.84 (dd, J=9.3 Hz, 9.3 Hz, 1H), 3.61 (td, J=9.4, 4.8 Hz, 1H), 3.57 (dd, J=9.3, 3.9 Hz, 1H), 3.51 (dd, J=10.3 Hz, 10.3 Hz, 1H), 3.42 (s, 3H), 3.25 (dd, J=9.4 Hz, 9.4 Hz, 1H), 1.72-1.57 (m, 2H), 1.39 (m, 2H), 1.26 (b, 16H), 0.87 (t, J=6.8 Hz, 3H) ppm. ¹³C NMR (101 MHZ, CDCl₃) δ 102.71, 99.65, 80.27, 77.32, 77.20, 77.00, 76.68, 72.93, 71.86, 68.44, 62.49, 55.46, 34.23, 31.89, 29.62, 29.59, 29.56, 29.53, 29.47, 29.43, 24.05, 22.66, 14.09 ppm. FT-IR (ATR) 3441, 2916, 2854, 1741, 1465, 1381, 1342, 1134, 1072, 1041, 987, 902, 648, 586, 493 cm 1. HRMS (ESI⁺) m/z: [M+H]⁺ Calculated for C₁₉H₃₆O₆H⁺ 361.2585; found 361.2586.

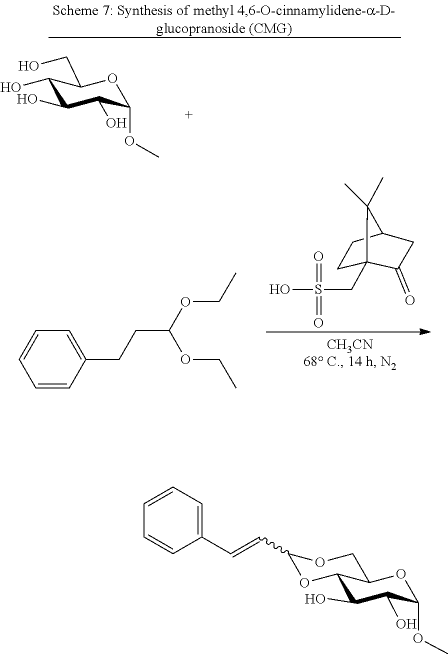

Synthesis of methyl 4,6-O-cinnamylidene-α-D-glucopyranoside (CMG): To a solution of methyl α-D-glucopyranoside (80.0 g, 412 mmol) in anhydrous MeCN (ca. 550 mL) under N₂ was added cinnamaldehyde diethyl acetal (111.2 g, 540 mmol) and (1S)-(+)-10-camphorsulfonic acid (480 mg, 2.1 mmol) to obtain a pale pink solution with partially insoluble methyl α-D-glucopyranoside. The reaction flask was equipped with a circulating condenser and heated in an oil bath at 68° C. under N₂ for 14 h to obtain a brown homogeneous solution. The reaction mixture was cooled to room temperature and quenched by addition of 10 mL of saturated KHCO₃ solution (aq.). Ethyl acetate (500 mL) was added, and the organic layer was washed with water (250 mL) and brine (150 mL), dried over anhydrous Na₂SO₄, filtered, and concentrated to ca. 500 mL in vacuo. The concentrated solution was precipitated into 6 L of hexanes/diethyl ether (4:1, v:v), the solid was collected by filtration, and residual solvent was removed in vacuo to give methyl 4,6-O-cinnamylidene-α-D-glucopyranoside as an off-white solid (101 g, 80% yield). The obtained product was observed to contain 2-4% of cinnamaldehyde. ¹H NMR (400 MHZ, CDCl₃) δ 7.42-7.37 (m, 2H), 7.35-7.26 (m, 3H), 6.81 (d, J=16.2, 1H), 6.20 (dd, J=16.2, 4.8 Hz, 1H), 5.18 (d, J=4.8 Hz, 1H), 4.79 (d, J=3.9 Hz, 1H), 4.23 (dd, J=9.9, 4.6 Hz, 1H), 3.91 (dd, J=9.2, 9.2 Hz, 1H), 3.75 (td, J=9.8, 4.6 Hz, 1H), 3.67 (dd, J=10.6 Hz, 9.2 Hz, 1H), 3.61 (dd, J=9.2, 3.9 Hz, 1H), 3.45 (s, 3H), 3.41 (dd, J=9.2 Hz, 9.2 Hz, 1H), 2.68 (d, J=2.0 Hz, 1H), 2.21 (d, J=9.8 Hz, 1H) ppm. ¹³C NMR (101 MHZ, CDCl₃) δ 135.89, 134.42, 128.71, 128.51, 127.03, 124.19, 101.22, 99.85, 80.62, 77.36, 73.14, 71.97, 68.73, 62.48, 60.55, 55.68 ppm. FT-IR (ATR) 3599-3105, 2994-2781, 1741, 1665, 1497, 1452, 1375, 1264, 1149, 1125, 1053, 964, 835, 742, 685, 649 cm⁻¹. HRMS (ESI⁺) m/z: [M+H]⁺ Calculated for C₁₆H₂₀O₆H⁺ 309.1333; found 309.1325.

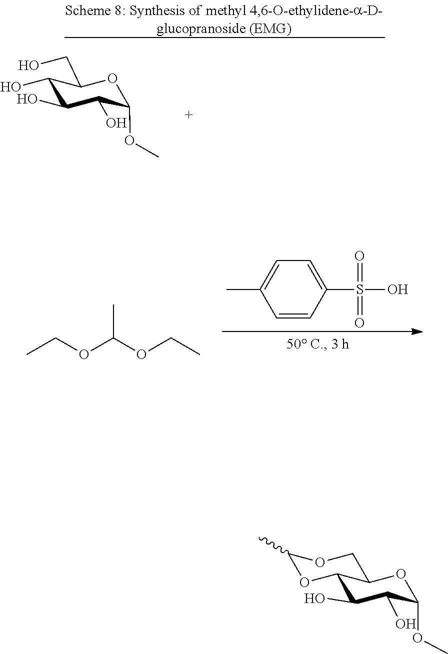

Synthesis of methyl 4,6-O-ethylidene-α-D-glucopyranoside (EMG): To a 250 mL round bottom flask equipped with a stir bar was added methyl α-D-glucopyranoside (50.2316 g, 259 mmol), acetaldehyde diethyl acetal (76.2 g, 92 mL, 644 mmol), and p-toluenesulfonic acid monohydrate (2.9547 g, 15.5 mmol). The reaction was stirred at 50° C. for 3 h to obtain a colorless homogeneous solution, cooled to room temperature, and then concentrated in vacuo. The crude mixture was dissolved in DCM (150 mL), neutralized with saturated K₂CO₃ solution (aq.), and washed with water and brine. The organic layer was dried over anhydrous Na₂SO₄, filtered, and DCM was removed in vacuo to give ethyl 4,6-O-ethylidene-α-D-glucopyranoside as a white solid (54.5 g, 96% yield). ¹H NMR (400 MHZ, CDCl₃) δ 4.76 (d, J=3.9 Hz, 1H), 4.73 (q, J=5.0 Hz, 1H), 4.11 (dd, J=10.1, 4.8 Hz, 1H), 3.85 (dd, J=9.2 Hz, 9.2 Hz, 1H), 3.65 (td, J=9.8, 4.7 Hz, 1H), 3.59-3.49 (m, 2H), 3.44 (s, 3H), 3.28 (dd, J=9.4 Hz, 9.4 Hz, 1H), 1.38 (d, J=5.0 Hz, 3H) ppm. ¹³C NMR (101 MHZ, CDCl₃) δ 99.87, 80.63, 73.50, 72.41, 68.87, 62.82, 55.98, 20.80 ppm. FT-IR (ATR) 3364, 2986, 2916, 1636, 1450, 1389, 1273, 1088, 1034, 955, 902, 841, 741, 664 cm⁻¹. HRMS (ESI⁺) m/z: [M+H]⁺ Calculated for C₉H₁₆O₆H⁺ 221.1020; found 221.1014.

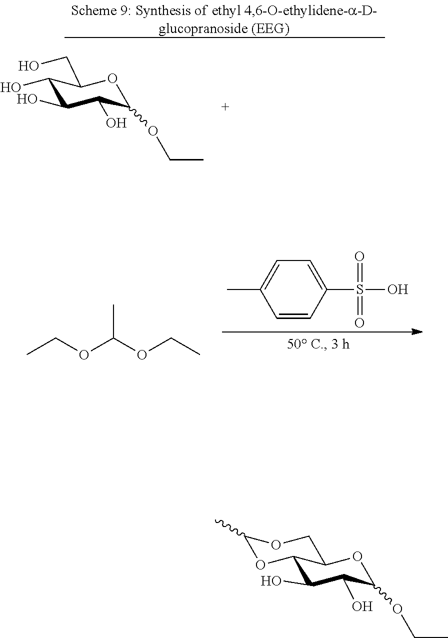

Synthesis of ethyl 4,6-O-ethylidene-D-glucopyranoside (EEG): To a 50 mL round bottom flask equipped with a stir bar was added ethyl D-glucopyranoside (5.0416 g, 24 mmol) obtained according to Scheme 2, acetaldehyde diethyl acetal (7.1 g, 8.5 mL, 60 mmol), and p-toluenesulfonic acid monohydrate (272.1 mg, 1.43 mmol). The reaction was stirred at 50° C. for 3 h to obtain a turbid yellow solution, cooled to room temperature, and then concentrated in vacuo. The crude mixtures of five batches (5 g scale each) were dissolved in DCM (100 mL), neutralized with saturated K₂CO₃ solution (aq.), and washed with water and brine. The organic layer was dried over anhydrous Na₂SO₄, filtered, and DCM was removed in vacuo to give ethyl 4,6-O-ethylidene-D-glucopyranoside as a brown solid (25.54 g, 91% yield). ¹H NMR (400 MHZ, CDCl₃) δ 4.85 (d, J=3.9 Hz, 1H), 4.72 (q, J=5.0 Hz, 1H), 4.08 (dd, J=10.2, 4.9 Hz, 1H), 3.84 (dd, J=9.2 Hz, 9.2 Hz, 1H), 3.80-3.62 (m, 3H), 3.57-3.48 (m, 5H), 3.27 (dd, J=9.4 Hz, 9.4 Hz, 1H), 1.37 (d, J=5.1 Hz, 3H), 1.24 (t, J=7.1 Hz, 3H) ppm. ¹³C NMR (101 MHZ, CDCl₃) δ 99.79, 98.55, 80.41, 73.06, 72.02, 68.55, 64.12, 62.56, 20.46, 15.15 ppm. FT-IR (ATR) 3410, 2978, 2877, 1736, 1450, 1389, 1342, 1080, 1049, 1018, 925, 895, 841, 741, 663 cm⁻¹. HRMS (ESI⁺) m/z: [M+NH4]⁺ Calculated for C₁₀H₁₈O₆+NH₄⁺252.1442; found 252.1436.

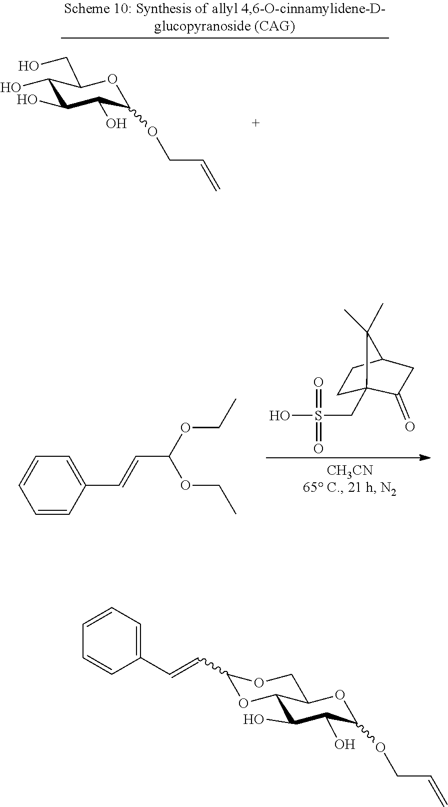

Synthesis of allyl 4,6-O-cinnamylidene-D-glucopyranoside (CAG): To a solution of allyl α-d-glucopyranoside obtained according to Scheme 4 (3.81 g, 17.3 mmol) in anhydrous MeCN (ca. 120 mL) under N₂ was added cinnamaldehyde diethyl acetal (4.01 g, 22.5 mmol) and (1S)-(+)-10-camphorsulfonic acid (19 mg, 82 μmol). The reaction was heated in an oil bath at 65° C. under N₂ for 21 h, cooled to room temperature, and quenched by adding 0.7 mL of saturated NaHCO₃ solution (aq). The mixture was dried over MgSO₄ and filtered through a celite pad. The filtrate was concentrated in vacuo and the product was isolated by column chromatography (95:5 DCM/methanol, v/v), to give allyl 4,6-O-cinnamylidene-D-glucopyranoside as an off-white solid (3.52 g, 61% yield). ¹H NMR (400 MHZ, CD₂Cl₂) δ 7.54-7.14 (m, 5H), 6.74 (d, J=16.1, 1H), 6.13 (dd, J=16.2, 4.7 Hz, 1H), 5.93-5.76 (m, 1H), 5.25 (dd, J=17.2 Hz, 1.6 Hz, 1H), 5.17 (d, J=11.8 Hz, 1H) 5.11 (d, J=4.8 Hz, 1H), 4.86 (d, J=3.9 Hz, 1H), 4.20-4.11 (m, 2H), 3.97 (dd, J=12.8 Hz, 6.4 Hz, 1H), 3.88 (dd, J=9.3 Hz, 9.3 Hz, 1H), 3.79-3.66 (m, 1H), 3.59-3.51 (m, 1H), 3.43 (dd, J=17.3 Hz, 8.4 Hz, 1H), 3.34 (dd, J=9.4 Hz, 9.4 Hz, 1H) ppm. ¹³C NMR (101 MHZ, CD₂Cl₂) δ 135.89, 133.91, 133.69, 128.58, 128.33, 126.82, 124.53, 117.60, 102.27, 101.02, 98.1, 80.63, 74.68, 73.23, 71.68, 70.38, 68.75, 62.63 ppm. FT-IR (ATR) 3372, 2924, 2870, 1659, 1450, 1373, 1273, 1057, 955, 964, 841, 748, 694, 656, 594, 448 cm⁻¹. HRMS (ESI*) m/z: [M+H]⁺ Calculated for C₁₈H₂₂OCH⁺ 335.1489; found 335.1489.

All other monomers listed in Table 1 were obtained commercially.

### Example 3: Preparation of Polymers

The glucopyranoside monomers as prepared in Example 2, or as obtained commercially, were used to prepare example polymers according to the following procedures.

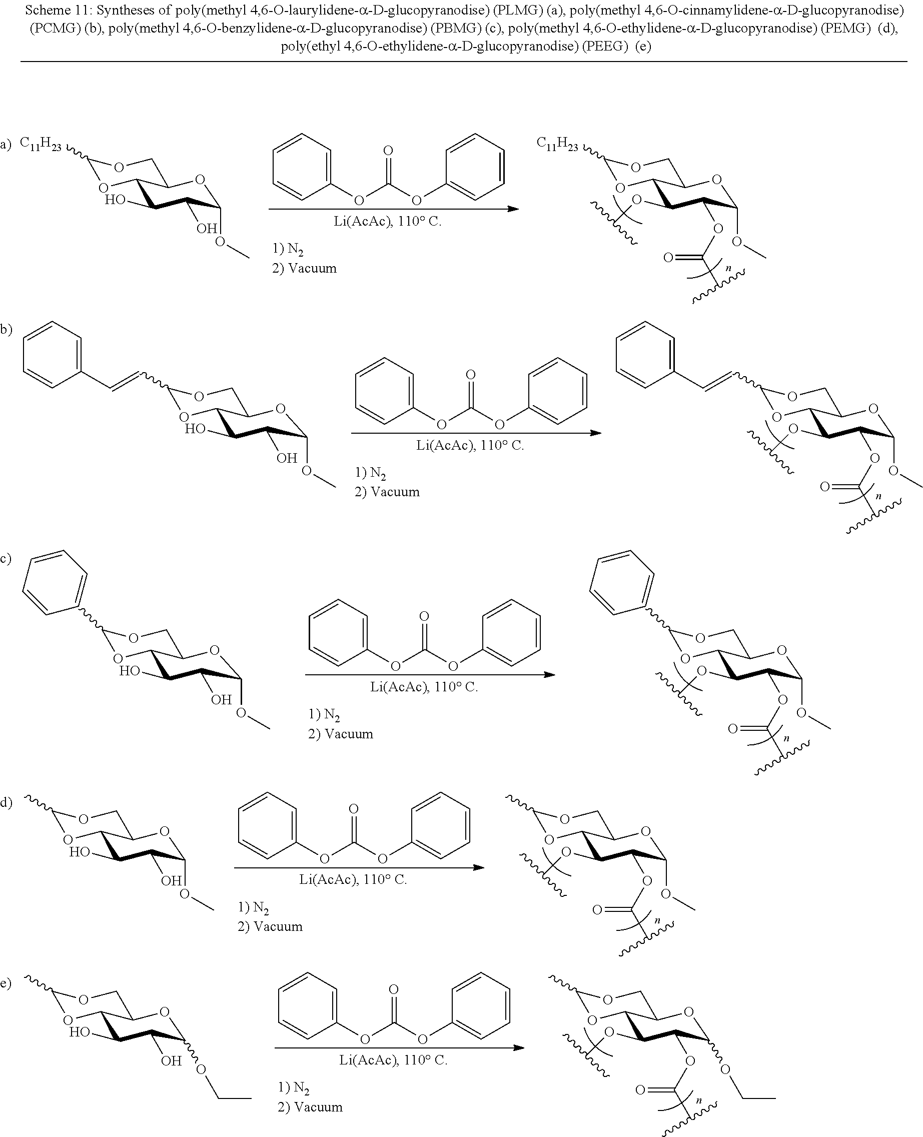

### General Procedure for the Melt-Phase Synthesis of Poly(Glucose Carbonate) s Using Diphenyl Carbonate:

Step 1: Transcarbonation: Acetal protected D-alkyl glucose monomer (1 equiv.), diphenyl carbonate (1 equiv.), and lithium acetyl acetonate (1-10 mol %) were charged into a round bottom Schlenk flask. The flask was equipped with a condenser, placed under positive N₂ flow, and heated in an oil bath at 110° C. The solid reactants melted and formed a homogeneous solution within ca. 30-40 min, at which time phenol could be observed crystallizing in the condenser. The reaction was allowed to stir an additional 2-3 h under N₂ flow (>1 mL/min) before proceeding to step 2.

Step 2: Polycondensation: After 2-3 h of transcarbonation, the reaction mixture was a viscous liquid. The condenser was replaced with a glass stopper, N₂ flow was stopped, and the reaction was placed under vacuum for 12-14 h, reaching a stable pressure of ca. 50 millitorr at completion. The reaction mixture was allowed to cool to room temperature and dissolved in minimal THF. The polymer products were isolated through precipitation into methanol, centrifugation, and removal of residual solvent in vacuo to give dull white solids. Yields are given below, based upon 95% monomer conversions.

The polymers produced are summarized in Table 2.

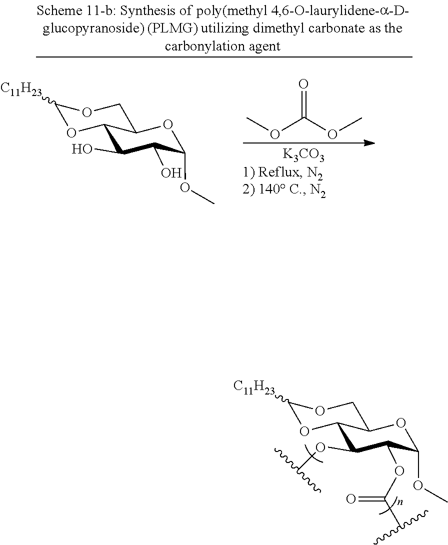

### General Procedure for the Synthesis of Poly(Glucose Carbonate) s Using Dimethyl Carbonate:

Step 1: Transcarbonation: Acetal protected D-alkyl glucose monomer (1 equiv.), dimethyl carbonate (10 equiv.), and potassium carbonate (5 mol %) were charged into a round bottom Schlenk flask. The flask was equipped with a Vigreux column, placed under positive N₂ flow, and heated in an oil bath at 100° C. to reflux the dimethyl carbonate. The reactants formed a homogeneous solution within about 20 min, at which time methanol could be observed condensing in the Vigreux column. The reaction was allowed to stir an additional 24 h under N₂ flow (>1 mL/min) before proceeding to step 2.

Step 2: Polycondensation: After 24 h of transcarbonation, the Vigreux column was removed, and the reaction was heated to 140° C. to remove the remaining dimethyl carbonate. The reaction was allowed to stir an additional 24 h under N₂ flow (>1 mL/min) before it was allowed to cool to room temperature and dissolved in minimal THF. The polymer products were isolated through precipitation into water, filtration, and removal of residual solvent in vacuo to give white solids.

The polymer produced is summarised in Table 2.

TABLE 2

| Structure | Name | Abbreviation | Yield |
|---|---|---|---|
| 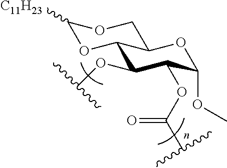 | poly(methyl 4,6-O- laurylidene-α-D- glucopyranoside) | (PLMG) | 79% |
| 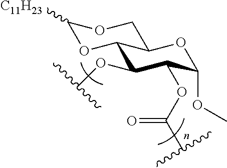 | poly(methyl 4,6-O- laurylidene-α-D- glucopyranoside) | (PLMG) | 28%¹ |
| 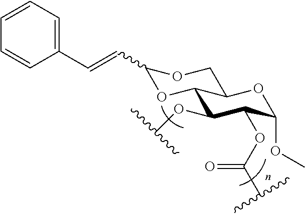 | poly(methyl 4,6-O- cinnamylidene-α-D- glucopyranoside) | (PCMG) | 63% |
| 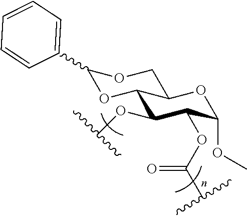 | poly(methyl 4,6-O- benzylidene-α-D- glucopyranoside) | (PBMG) | 73% |
| 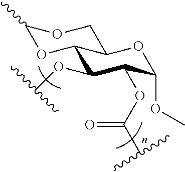 | poly(methyl 4,6-O- ethylidene-α-D- glucopyranoside) | (PEMG) | 78% |
| 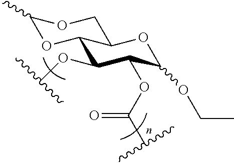 | poly(ethyl 4,6-O- ethylidene-D- glucopyranoside) | (PEEG) | 29% |

¹this polymer was produced according to Scheme 11-b. All other polymers were produced according to Scheme 11.

### Example 4: Post-Polymerization Modification

The PCMG polymer prepared in Example 2 was subjected to acetal deprotection to yield an example deprotected polymer according to the following procedure.

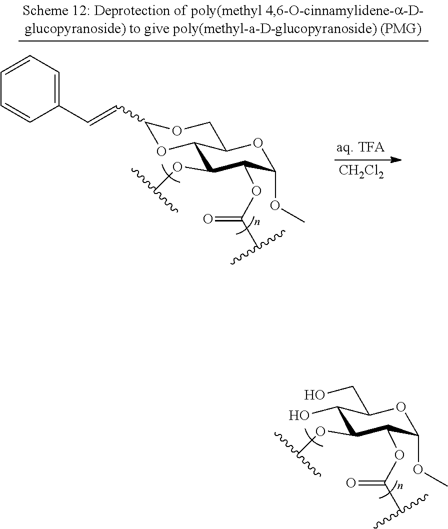

Procedure for deprotection of poly(methyl 4,6-O-cinnamylidene-α-D-glucopyranoside) to give poly(methyl-α-D-glucopyranoside) (PMG): To a solution of acetal protected poly(methyl 4,6-O-cinnamylidene-α-D-glucopyranoside) (PCMG) (1 equiv.) in DCM (0.08 g/mL) was slowly added trifluoroacetic acid (1.9 equiv., 88% in H₂O or 0.26 equiv., 12% in H₂O) and the reaction was stirred for 12-16 h at room temperature. The reaction solution was concentrated to about half the original volume and the polymer products were isolated through precipitation into ice-cold diethyl ether, centrifugation, and removal of residual solvent in vacuo to give poly(methyl-α-D-glucopyranoside) (PMG) as an off-white/tan solid. When using 1.9 equiv. TFA, 88% in H₂O, the yield was 50-60%. When using 0.26 equiv. TFA, 12% in H₂O, the yield was ˜90%. In both cases, deprotection was quantitative, as determined by ¹H NMR.

### Example 5: Determination of Polymer Properties

The polymers prepared in Example 3 (scheme 11) and Example 4 were tested to determine polymer properties according to the methods below.

### Preparation of Samples for Testing

For molar mass determination, polymer samples (recovered from precipitation) were dissolved in THF (containing 1% toluene flow marker) at a concentration of ˜7 mg/mL and filtered through a 0.2 μm PTFE filter. For degradation and glass transition temperatures, samples were used directly as obtained from precipitation. For contact angle measurements, samples were dissolved in cyclohexanone at a concentration of 10 mg/ml and spun cast onto silicon wafers at 500 rpm for 5 s, followed by 2000 rpm for 15 s.

### Test Methods

Molar masses (Mₙ, M_{w}, and Mₚ) and dispersity values (Ð) were determined by size exclusion chromatography (SEC) in tetrahydrofuran (THF) with refractive index detection and calibration using polystyrene standards for all polymers other than PEMG. SEC eluting with THF was conducted on a Waters chromatography, Inc. (Milford, MA) system equipped with an isocratic pump model 1515, a differential refractometer model 2414, and a Four-column set including a guard column (PLgel 5 μm, 50×7.5 mm) and three Styragel columns (PLgel 5 μm Mixed C, 500 Å, and 104 Å, 300×7.5 mm columns). The system was operated at 40° C. with a flow rate of 1 mL/min. Data were analyzed using Breeze software from Waters Chromatography, Inc. (Milford, MA). Molar masses were determined relative to polystyrene standards (300-467,000 Da) purchased from Polymer Laboratories, Inc. (Amherst, MA). Polymer solutions were prepared at a concentration of about 3-8 mg/ml with 0.05 vol % toluene as a flow rate marker and an injection volume of 200 μL was used.

For PEMG, which is THF insoluble, molar masses (Mₙ, M_{w}) and dispersity values (D) were determined by size exclusion chromatography (SEC) in dimethyl formamide (DMF) with refractive index detection and calibration using poly(methyl methacrylate) standards. SEC eluting with DMF was conducted on a Tosoh Corporation (Tokyo, Japan) model HLC-8320 EcoSEC system with a two-column set of TOSOH Bioscience TSKgel columns (SuperAW4000, 6 μm, 150×6.0 mm) and a guard column (SuperAW-L, 7 μm, 35×4.6 mm).

The system was operated at 40° C. with a flow rate of 0.60 mL/min. Data were analyzed using EcoSEC software from Tosoh Corporation (Tokyo, Japan). Molar masses were determined relative to poly(methyl methacrylate) standards (550-265,300 Da) purchased from Agilent Technologies (Santa Clara, CA). Polymer solutions were prepared at a concentration of ca. 3-8 mg/mL and an injection volume of 200 μL was used.

Glass transition temperatures (T_{g}) were measured by differential scanning calorimetry (DSC) on a Mettler-Toledo DSC3/700/1190 (Mettler-Toledo, Inc., Columbus, OH) under a nitrogen gas atmosphere. Measurements were performed on sample masses of ca. 5-10 mg in aluminum pans with heating and cooling rates of 10° C./min and three heating and cooling cycles were conducted. Measurements were analyzed using Mettler-Toledo STAR^{e} v. 15.00a software. The T_{g} was taken as the midpoint of the inflection tangent of the third heating scan.

Degradation temperatures (Ta) were determined by thermogravimetric analysis (TGA), performed under N₂ atmosphere using a Mettler-Toledo TGA2/1100/464, at a range of 25-500° C. with a heating rate of 10° C./min. Data were analyzed using Mettler-Toledo STAR^{e} v. 15.00a software. The T_{d} values reported were measured as the onset of thermal decomposition, determined at either 10% (PMG, to ensure that the measurement of thermal decomposition was made for the polymer breakdown and not merely loss of residual solvent) or 5% (all other polymers) mass loss.

Water contact angle measurements were performed as a series of static contact angles measured using the sessile drop technique on an Attension Theta optical tensiometer (Biolin Scientific), observed over the course of 4 minutes. Drops were fitted with a Young-Laplace formula to calculate the static contact angle in the Theta software (Biolin Scientific).

### Results

The results of the polymer property testing are given in Table 3.

TABLE 3

| | SEC Data | | | | | | | |
|---|---|---|---|---|---|---|---|---|
| | Mₙ | M_{w} | Mₚ | | Thermal Data | | H₂O Contact Angle | |
| Polymer | (kDa) | (kDa) | (kDa) | Ð | T_{d}(° C.) | T_{g}(° C.) | t = 0 s (°) | t = 240 s (°) |
| PLMG | 9.5 | 17.9 | 11.8 | 1.9 | 280 | 44 | 104.3 | 101.8 |
| PCMG | 1.3 | 1.8 | 1.4 | 1.4 | 260 | 159 | 95.9 | 90.1 |
| PBMG | 2.0 | 4.0 | 3.3 | 2.0 | 260 | 138 | 67.3 | 62.9 |
| PEMG | 1.9 | 3.1 | — | 1.7 | 233 | N/A | 67.8 | 30.2 |
| PEEG | 7.1 | 10.4 | 8.2 | 1.5 | 300 | 180 | 71.4 | 67.1 |
| PMG* | 1.4 | 2.1 | 1.7 | 1.5 | 240 | 168 | 57.9 | 29.6 |

*Determined on sample prepared according to Example 4, when using 1.9 equiv. TFA, 88% in H₂O

The results of Table 3 show that the polymers of Examples 3 and 4 have a desirable diversity of molar mass, thermal, and water contact angle properties. The range of polymer parameters that are achievable mean that the polymers of the invention are “tuneable”, i.e. that the example polymers can advantageously provide a range of chemical, thermal, degradation and mechanical properties, meaning they can be exploited in a diverse range of end-applications.

### Example 6: Biodegradation Testing

The PMG polymer prepared in Example 4 was subject to biodegradation testing according to the procedure below.

### Preparation of Sample for Testing

The polymer sample was recovered from precipitation, dried in vacuo, and ground into a fine powder with a mortar and pestle. The sample was packaged under nitrogen and shipped to RespirTek, Inc. and upon arrival, the sample was stored as received under ambient conditions. For testing, a total reactor composition of 5 L was prepared from 4.9 mg of PMG, 3.5 L CO₂ free mineral stock solution, 495.2 mL of deionized water, and 4.8 mL of biomass (3.346 mg/mL total suspended solids). A positive control reactor was prepared with 211.1 mL sodium benzoate stock solution (0.6 g/L), 3.5 mL CO₂ free mineral stock solution, 284.1 mL deionized water, and 4.8 mL of biomass (3.346 mg/mL total suspended solids). A blank was prepared with 3.5 L CO₂ free mineral stock solution, 495.2 mL of deionized water, and 4.8 mL of biomass (3.346 mg/mL total suspended solids).

### Biodegradation Test Method

The testing method employed by RespirTek, Inc. (on a fee for service basis) was the OECD 310 ready biodegradability test, which monitors the biological conversion of organic carbon to inorganic carbon through the activity of microorganisms relative to a biodegradable control. Three solutions were prepared (PMG, sodium benzoate positive control, and a blank) as described above and homogenized with stirring and transferred to vials that were capped with aluminum crimp caps with PTFE/silicone septa. A day zero sample was collected and basified, and the remaining vials were placed on a shaker (250 rpm) under light free conditions for the duration of testing throughout which seven sampling events occurred.

### Results

The PMG sample achieved 63.3% biodegradation during the testing described above, and met method requirements for an Ultimate Biodegradability classification.

1. A polymer derived from monomers (A) and (B): 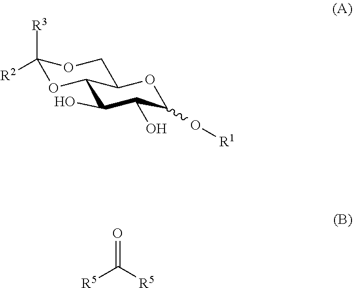
wherein
R¹ is at each occurrence hydrocarbyl with 1 to 40 C atoms that is optionally substituted and optionally comprises one or more hetero atoms;
R² is at each occurrence H, or hydrocarbyl with 1 to 40 C atoms that is optionally substituted and optionally comprises one or more hetero atoms;
R³ is at each occurrence H, or hydrocarbyl with 1 to 40 C atoms that is optionally substituted and optionally comprises one or more hetero atoms;
R⁵ is a leaving group selected from halogen, imidazole, —OR⁴, —SR⁴, or —N(R⁴)₂;
R⁴ is hydrocarbyl with 1 to 40 C atoms that is optionally substituted and optionally comprises one or more hetero atoms;
each R⁴ may be the same or different; and
each R⁵ may be the same or different.

2. A polymer according to claim 1, wherein R¹⁻³ are independently of each other selected from straight-chain or branched-chain C₁-C₂₀ alkyl, C₂-C₂₀ alkenyl, C₂-C₂₀ alkynyl, or C₅-C₂₀ aryl, each of which is optionally substituted.

3. A polymer according to claim 1, wherein R¹ is C₁-C₂₀-alkyl, C₂-C₂₀-alkenyl, or C₅-C₂₀ aryl, each of which is optionally substituted.

4. A polymer according to claim 1, wherein R¹ is methyl, ethyl, or allyl.

5. A polymer according to claim 1, wherein R² is H, C₁-C₂₀-alkyl, C₂-C₂₀-alkenyl, or C₅-C₂₀ aryl, each of which is optionally substituted.

6. A polymer according to claim 1, wherein R² is H, phenyl, C₁-C₂₀-alkyl, or styrenyl.

7. A polymer according to claim 1, wherein R³ is H, C₁-C₂₀-alkyl, C₂-C₂₀-alkenyl or C₅-C₂₀ aryl, each of which is optionally substituted.

8. A polymer according to claim 1, wherein R³ is H, phenyl, C₁-C₂₀-alkyl, or styrenyl.

9. A polymer according to claim 1, wherein at least one of R² and R³ is H.

10. A polymer according to claim 1, wherein R⁵ is halogen or —OR⁴ and R⁴ is C₁-C₂₀ alkyl or C₅-C₂₀ aryl, each of which is optionally substituted.

11. A polymer according to claim 1, wherein R⁵ is —OR⁴, wherein R⁴ is C₁-C₂₀ alkyl or C₅-C₂₀ aryl, each of which is optionally substituted.

12. A polymer according to claim 1, wherein said polymer has a backbone consisting of a repeat unit of formula (I):

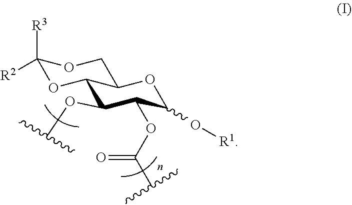

13. A polymer according to claim 1, wherein said polymer is PLMG, PCMG, PBMG, PEMG, or PEEG.

14. A polymer according to claim 1, which undergoes degradation meeting the OECD 310 standard.

15. A process for preparing a polymer according to claim 1, wherein said process is a condensation polymerization.

16. A process according to claim 15, comprising reacting a compound of formula (A) with a compound of formula (B) 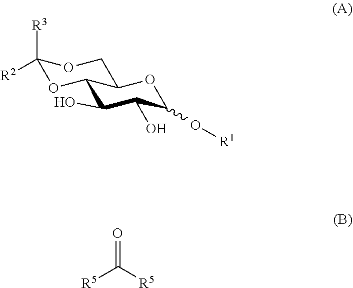
wherein R¹, R², R³, and R⁵ are as defined in claim 1.

17. A polymer comprising a repeat unit of formula (II) and at least one terminal group of formula (II): 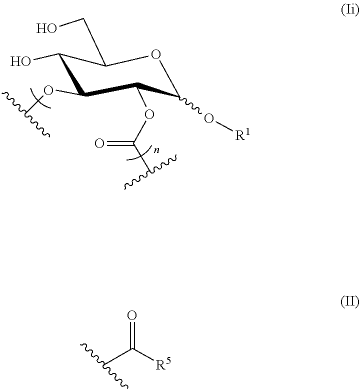
wherein
R¹ is at each occurrence hydrocarbyl with 1 to 40 C atoms that is optionally substituted and optionally comprises one or more hetero atoms;
R⁵ is a leaving group selected from halogen, imidazole, —OR⁴, —SR⁴, or —N(R⁴)₂;
R⁴ or hydrocarbyl with 1 to 40 C atoms that is optionally substituted and optionally comprises one or more hetero atoms;
each R⁴ may be the same or different;
each R⁵ may be the same or different;
n is an integer from 2 to 200; and
the terminal group of formula (II) is derived from a monomer of the polymer.

18. A polymer according to claim 17, having formula: 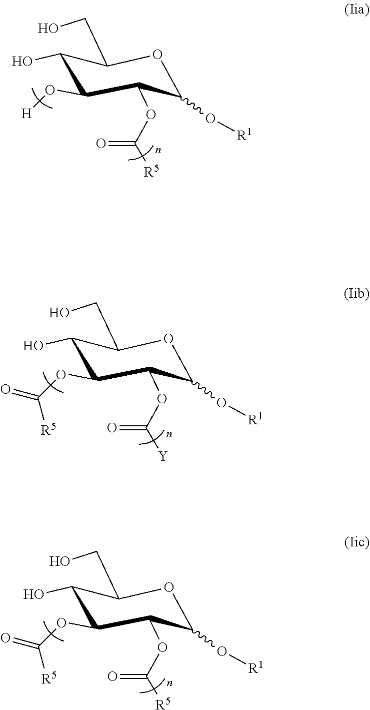
wherein Y is selected from:

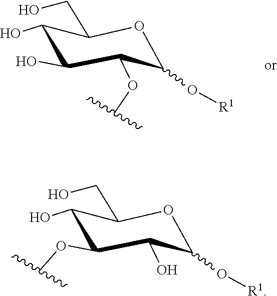

19. A polymer according to claim 17, further comprising a repeat unit of formula (I):

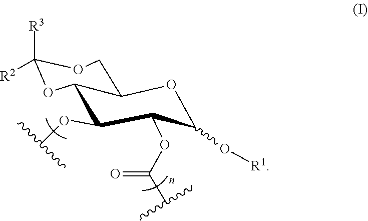

20. A polymer according to claim 17, wherein said polymer does not comprise any repeat units of formula (I).
